(19) United States
(12) Patent Application Publication
(10) Pub. No.: US 2026/0040224 A1
(43) Pub. Date: Feb. 5, 2026

(54) METHODS AND APPARATUS FOR RESOURCE EFFICIENT SIGNALING TO LP-WUR

(71) Applicant: Huawei Technologies Co., Ltd., Shenzhen (CN)

(72) Inventors: Ruikang Yang, Princeton, NJ (US); Hussain Elkotby, Belmont, MA (US); Weimin Xiao, Hoffman Estates, IL (US)

(21) Appl. No.: 19/301,613

(22) Filed: Aug. 15, 2025

Related U.S. Application Data
(63) Continuation of application No. PCT/US2024/016180, filed on Feb. 16, 2024.
(60) Provisional application No. 63/485,417, filed on Feb. 16, 2023.
(60) Provisional application No. 63/485,403, filed on Feb. 16, 2023.

(51) Int. Cl. H04W 52/02; H04B 17/318

(52) U.S. Cl. CPC H04W 52/0235; H04B 17/328; H04W 52/0245

(57) ABSTRACT

Various aspects of the present disclosure generally relate to wireless communication. In some aspects, a method implemented in a wireless device includes receiving a low-power wake-up signal (LP-WUS) configuration from a network side device indicating a set of frequency resources allocated for LP-WUS transmission. The method also includes determining one or more subsets of the set of frequency resources to be allocated to one or more bits associated with the LP-WUS transmission according to the LP-WUS configuration and determining a first reference signal and a second reference signal according to the LP-WUS configuration. The method also includes receiving one or more signals over the set of frequency resources from the network side device, determining one or more signal levels according to the one or more signals and determining the one or more bits according to the one or more signal levels, the first reference signal, and the second reference signal.

### PRIORITY CLAIM AND CROSS-REFERENCE

This patent application is a continuation of International Application No. PCT/US2024/016108, filed on Feb. 16, 2024 and entitled “Methods and Apparatus for Resource Efficient Signaling to LP-WUR,” which claims priority to U.S. Provisional Application No. 63/485,403, filed on Feb. 16, 2023 and entitled “Methods for Efficient Support of In-Band Selectivity and High Data for LP-WURS” and to U.S. Provisional Application No. 63/485,417, filed on Feb. 16, 2023 entitled “Methods and Apparatus for Resource Efficient Signaling to LP-WUR,” applications of which are hereby incorporated by reference herein as if reproduced in their entireties.

### TECHNICAL FIELD

The present disclosure relates generally to methods and apparatus for wireless communications, and, in particular embodiments, to methods and apparatus for resource efficient signaling to a low power wake up radio (LP-WUR).

### BACKGROUND

In 3GPP meetings, on-off key (OOK) and frequency shift keying (FSK) are being discussed as potential modulation schemes and a few architectures are being considered. Target data rates of 100 kbps which may require higher order modulation than OOK and 2-FSK.

A Study item on low-power wake-up signal (LP-WUS) and low-power wake-up receiver (LP-WUR) for NR was approved in 3GPP RAN #94e meeting and revised in RAN #97e. The study covers low-power receiver architectures, signal and protocol design, and evaluation methodology targeting metrics such as power saving gain, latency, coverage availability, coexistence with non-low-power-WUR UEs, and network resource overhead. Several types of receiver architectures, supporting OOK modulation scheme, were agreed in RAN1 #110 bis-e including architectures with RF envelope detection, heterodyne architecture with intermediate frequency (IF) envelope detection, and homodyne/zero-IF architecture with baseband (BB) envelope detection. These architectures may also be suitable for other modulation schemes such as Frequency Shift Keying (FSK). Discussions in 3GPP RAN1 meetings are still ongoing on the applicability of other modulation schemes for LP-WURs. Further, discussions on target data rates of ˜100 kbps are ongoing, which may require the support of modulation orders higher than that supported by OOK and 2-FSK. In this document, an LP-WUS design that enables resource efficient support of higher order modulation for LP-WURs is provided.

### SUMMARY

In accordance with an embodiment, a method implemented in a wireless device includes receiving a low-power wake-up signal (LP-WUS) configuration from a network side device, the LP-WUS configuration indicating a set of frequency resources allocated for LP-WUS transmission. The method also includes determining one or more subsets of the set of frequency resources to be allocated to one or more bits associated with the LP-WUS transmission according to the LP-WUS configuration and determining a first reference signal and a second reference signal according to the LP-WUS configuration. The method also includes receiving one or more signals over the set of frequency resources from the network side device. The method also includes determining one or more signal levels according to the one or more signals and determining the one or more bits according to the one or more signal levels, the first reference signal, and the second reference signal.

In an embodiment, the determining the one or more bits according to the one or more signal levels, the first reference signal, and the second reference signal includes determining a relative difference with respect to the first reference signal and the second reference signal. In an embodiment, the first reference signal includes a first intensity representing a bit “0”, wherein the second reference signal comprises a second intensity representing a bit “1”, and wherein the determining the one or more bits according to the one or more signal levels, the first reference signal, and the second reference signal includes decoding a first bit of the one or more bits to be a “1” when a difference between a first one of the one or more signal levels and the first reference signal is less than a difference between the first one of the one or more signal levels and the second reference signal. In an embodiment, the first reference signal includes a first intensity representing a bit “0”, wherein the second reference signal includes a second intensity representing a bit “1”, and wherein the determining the one or more bits according to the one or more signal levels, the first reference signal, and the second reference signal includes decoding a first bit of the one or more bits to be a “0” when a difference between a first one of the one or more signal levels and the first reference signal is greater than a difference between the first one of the one or more signal levels and the second reference signal. In an embodiment, the method also includes passing one or more signals through an envelope detector prior to determining one or more signal levels according to the one or more signals. In an embodiment, each of the one or more signals comprises on-off keying (OOK) modulation. In an embodiment, the LP-WUS configuration is received in a higher layer signal. In an embodiment, the LP-WUS configuration further indicates at least one of a number of bits multiplexed in an orthogonal frequency-division multiplexing (OFDM) symbol, a number of LP-WUSs multiplexed in the frequency domain, the first subset of frequency resources allocated for a null reference signal, or the second subset of frequency resources allocated for consistent reference signal. In an embodiment, the first reference signal includes a first intensity and wherein the first intensity includes an estimated noise level intensity. In an embodiment, the second reference signal includes a second intensity and wherein the second intensity includes an estimated interference power and channel fading level intensity. In an embodiment, the determining the first reference signal and the second reference signal according to the LP-WUS configuration further includes receiving at least one of the first reference signal or the second reference signal from the network device.

In accordance with an embodiment, a method implemented in a wireless transmit/receive unit (WTRU) includes receiving a low-power wake-up signal (LP-WUS) configuration, the LP-WUS configuration indicating a set of frequency resources allocated for LP-WUS transmission. The method also includes determining one or more subsets of the set of frequency resources to be allocated to one or more bits associated with the LP-WUS transmission. The method also includes determining a first intensity based on a first signal received over a first subset of frequency resources. The method also includes determining a second intensity based on a second signal received over a second subset of frequency resources. The method also includes determining one or more signal levels based on one or more signals received over one or more subsets of the set of frequency resources. The method also includes detecting one or more bits based on the first intensity, the second intensity, and the one or more signal levels.

In an embodiment, the LP-WUS configuration is received in a higher layer signal. In an embodiment, the LP-WUS configuration further indicates at least one of a number of bits multiplexed in an orthogonal frequency-division multiplexing (OFDM) symbol, a number of LP-WUSs multiplexed in the frequency domain, the first subset of frequency resources allocated for a null reference signal, or the second subset of frequency resources allocated for consistent reference signal. In an embodiment, the first intensity is an estimated noise level intensity. In an embodiment, the second intensity is an estimated interference power and channel fading level intensity.

In accordance with an embodiment, a method implemented in a wireless transmit/receive unit (WTRU) for wireless communications includes receiving a low-power wake-up signal (LP-WUS) configuration indicating a first type of signaling, a second type of signaling, and a reference signal configuration, wherein the WTRU includes a first power state and a second power state. The method also includes determining a received signal strength based on the reference signal configuration. The method also includes, based on a first condition on the received signal strength, operating a receiver in the first power state and monitoring signals according to the first type of signaling. The method also includes, based on a second condition on the received signal strength, operating the receiver in the second power state and monitoring the signals according to the second type of signaling.

In an embodiment, the reference signal configuration further indicates a configured signal strength intensity. In an embodiment, the first condition being the received signal strength above the configured signal strength intensity. In an embodiment, the second condition being the received signal strength below the configured signal strength intensity. In an embodiment, the LP-WUS configuration further indicates a post envelope detection (ED) center frequency and a post ED bandwidth. In an embodiment, the first power state is lower than the second power state. In an embodiment, the monitoring of the signals according to the first type of signaling is based on the post-ED center frequency and the post-ED bandwidth. In an embodiment, the LP-WUS configuration further indicates one or more pre-ED center frequencies and one or more pre-ED bandwidths. In an embodiment, the monitoring of the signals according to the second type of signaling is based on the one or more pre-ED center frequencies and the one or more pre-ED bandwidths. In an embodiment, a radio frequency (RF) ED LP-WUR is utilized in the first power state. In an embodiment, an intermediate frequency (IF)/baseband (BB) ED LP-WUR is utilized in the second power state. In an embodiment, the LP-WUS configuration indicates at least one of support for a post-ED signaling design, a pre-ED signal, a post-ED signal, a LP-WUS transmission data rate, or a LP-WUS coding scheme and coding rate. In an embodiment, the first condition is post-ED signaling design being supported. In an embodiment, the second condition is post-ED signaling design not being supported.

In accordance with an embodiment, a method includes transmitting, by a base station, a low-power wake-up signal (LP-WUS) that produces a signal at least a specific intermediate/center frequency (IF) after/post envelope detection (ED) for wake-up signal (WUS) message demodulation and detection in a receiver.

In an embodiment, the LP-WUS transmitted by the base station includes at least two sets of contiguous frequency resources separated by the IF. In an embodiment, the LP-WUS signal transmitted by the base station includes at least one contiguous frequency resource, and background traffic signals at frequencies are separated from the contiguous frequency resource by the specific IF.

In accordance with an embodiment, a method includes transmitting, by a base station, a low-power wake-up signal (LP-WUS) that produces a signal at least a specific intermediate/center frequency (IF) after/post envelope detection (ED) for wake-up signal (WUS) message demodulation and detection in a receiver.

In an embodiment, the LP-WUS transmitted by the base station includes at least two sets of contiguous frequency resources separated by the IF. In an embodiment, the LP-WUS signal transmitted by the base station includes at least one contiguous frequency resource, and background traffic signals at frequencies are separated from the contiguous frequency resource by the specific IF.

In accordance with an embodiment, a method implemented in a base station includes determining a low-power wake-up signal (LP-WUS) configuration for a wireless device, wherein the LP-WUS configuration comprises one or more subsets of a set of frequency resources to be allocated to one or more bits associated with the LP-WUS. The method also includes transmitting the LP-WUS configuration to the wireless device, the LP-WUS configuration indicating a set of frequency resources allocated for LP-WUS transmission. The method also includes transmitting one or more signals over the set of frequency resources to the wireless device.

In an embodiment, the one or more signals are encoded based on on-off keying (OOK) modulation. In an embodiment, the LP-WUS configuration is received in a higher layer signal. In an embodiment, the LP-WUS configuration further indicates at least one of: a number of bits multiplexed in an orthogonal frequency-division multiplexing (OFDM) symbol, or a number of LP-WUSs multiplexed in the frequency domain. In an embodiment, the LP-WUS configuration further indicates a first subset of frequency resources allocated for a null reference signal. In an embodiment, the LP-WUS configuration further indicates a second subset of frequency resources allocated for consistent reference signal. In an embodiment, the method also includes determining the one or more signal levels according to one or more bits, a first reference signal, and second reference signal, wherein a bit having a first bit value is encoded according to the first reference signal and a bit having a second bit value is encoded according to the second reference signal. In an embodiment, the first reference signal includes a first intensity representing a bit “0”, wherein the second reference signal includes a second intensity representing a bit “1”, and wherein the method also includes determining the one or more signals according to the one or more bits, the first reference signal, and the second reference signal includes: encoding a first signal of the one or more signals to have an intensity equivalent to the first reference signal when a first bit of the one or more bits is a “1”; or encoding the first signal of the one or more signals to have an intensity equivalent to the second reference signal when the first bit of the one or more bits is a “0”. In an embodiment, the method also includes transmitting at least one of a first reference signal or a second reference signal to the wireless device.

In accordance with an embodiment, an apparatus includes at least one processor; and a non-transitory memory storing programming instructions that, when executed by at least one processor, cause the system to perform any of the methods described above.

In accordance with an embodiment, a non-transitory computer readable storage medium is provided that includes instructions that when executed by a processor cause the processor to perform any of the methods described above.

In accordance with an embodiment, a wireless transmit/receive unit (WTRU), includes at least one processor and a non-transitory computer readable storage medium storing programming, the programming including instructions that, when executed by the at least one processor, cause the WTRU to perform any of the methods disclosed above.

In accordance with an embodiment, a base station includes at least one processor and a non-transitory computer readable storage medium storing programming, the programming including instructions that, when executed by the at least one processor, cause the base station to perform any of the methods disclosed above.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a wireless system for low power wakeup signaling in accordance with an embodiment;

FIG. 2 shows an example Protocol plow/timeline based on DRX configuration in accordance with an embodiment;

FIG. 3 shows an example protocol flow/timeline based on eDRX (T_{eDRX}>1024 frame) configuration in accordance with an embodiment;

FIG. 4 shows An Example Protocol Flow/Timeline based on LP-WUS Configuration with UE Addressing in accordance with an embodiment;

FIG. 5 shows an example protocol flow/timeline based on LP-WUS configuration with UE group addressing in accordance with an embodiment;

FIG. 6 shows a survey of Low-Power Receiver Architectures in accordance with an embodiment;

FIG. 7 shows a basic block diagram for RF envelope detection receiver architecture in accordance with an embodiment;

FIG. 8 shows an example of synchronized switching/double-sampling receiver architecture in accordance with an embodiment;

FIG. 9 shows an example of a 2-Tone reception envelope detection receiver architecture in accordance with an embodiment;

FIG. 10 shows a basic block diagram for IF envelope detection receiver architecture in accordance with an embodiment;

FIG. 11 shows a basic block diagram for BB envelope detection receiver architecture in accordance with an embodiment;

FIG. 12 shows an example of sub-sampling receiver architecture in accordance with an embodiment;

FIG. 13 shows an example of uncertain IF receiver architecture in accordance with an embodiment;

FIG. 14 shows a representation of the dual uncertain-IF receiver architecture in accordance with an embodiment;

FIG. 15 is an example 1-bit FSK receiver architecture utilizing parallel OOK receivers in accordance with an embodiment;

FIG. 16 shows an example FSK receiver architecture utilizing analog domain FM-to-AM detector in accordance with an embodiment;

FIG. 17 shows an example FSK receiver architecture utilizing analog domain FM-to-AM detector in accordance with an embodiment;

FIG. 18 shows an example 1-bit FSK (2-FSK) receiver using the IF envelope detection-based receiver architecture in accordance with an embodiment;

FIG. 19 shows an example frequency response of a single OFDM symbol under LP-WUS dual-spectrum allocation;

FIG. 20 shows an example frequency response of a single OFDM symbol under LP-WUS dynamic design with single-spectrum allocation;

FIG. 21 shows an example OFDM-based transmitter architecture enabling LP-WUS dynamic design with single-spectrum allocation;

FIG. 22 is an illustration of the envelope detection operation on a signal's frequency spectrum;

FIG. 23A shows a reference radio architecture for conventional OOK;

FIG. 23B shows an RF spectrum of the input signal to the envelope detector for conventional OOK design;

FIG. 23C shows a reference radio architecture for synergistically generated IF envelope OOK;

FIG. 23D shows an RF spectrum of the input signal to the envelope detector for synergistically generated IF envelope OOK design and illustration of the process to produce IF envelope signal;

FIG. 24 is an illustration of feasibility/benefit of dynamic LP-WUS design for IF envelope detection receiver architectures;

FIG. 25 is an illustration of parallel bit stream support/generation using dynamic LP-WUS design for IF envelope detection receiver architectures;

FIG. 26 is an example frequency response of a single OFDM symbol under parallel LP-WUS design with dual-spectrum allocation;

FIG. 27 is an exemplary RF envelope detection receiver architecture supporting dual-spectrum allocation and dynamic LP-WUS design schemes;

FIG. 28 is an exemplary IF envelope detection receiver architecture supporting dual-spectrum allocation and dynamic LP-WUS design schemes;

FIG. 29 is an exemplary RF envelope detection receiver architecture supporting dual-spectrum allocation and dynamic LP-WUS design schemes with parallel bit streams;

FIG. 30 is an exemplary flow chart illustrating a process for UE dynamically switching between RF and IF/BB envelope detection architectures based on network's support;

FIG. 31 is an exemplary flow chart illustrating an embodiment process for a UE dynamically switching between RF and IF/BB envelope detection architectures based on network's support and RSRP measurements;

FIG. 32 is an exemplary flow chart illustrating an embodiment process for a UE dynamically switching between RF and IF/BB envelope detection architectures based on network's support and interfering signals measurements;

FIG. 33 shows an example 2-bit FSK receiver architecture utilizing parallel OOK receivers in accordance with an embodiment;

FIG. 34 shows an example 4-bit FSK, i.e., 16-FSK, receiver structure;

FIG. 35 shows an example algorithm, e.g., decision criteria, that the M-Dec, e.g., multi threshold comparator, unit may use;

FIG. 36 shows an example receiver structure 3600 as a parallel 4-bit receiver, that can receive N bits using only N+1 frequency resources based on a differential modulation/coding scheme;

FIG. 37 shows an example algorithm, e.g., decision criteria, that the M-Dec, e.g., multi threshold comparator, unit may use;

FIG. 38 shows an embodiment process implemented at a base station for processing an LP-WUS for a single LP-WUR using two fixed frequency resources as reference;

FIG. 39 shows an embodiment process implemented in a base station for processing a LP-WUS for a single LP-WUR using differential modulation;

FIG. 40 shows an embodiment process implemented in a UE for processing a LP-WUS using two fixed frequency resources as reference;

FIG. 41 shows an embodiment process implemented in a UE for processing a LP-WUS using one frequency resource as reference;

FIG. 42 illustrates an example communications system;

FIG. 43 illustrates an example communication system;

FIGS. 44A and 44B illustrate example devices that may implement the methods and teachings according to this disclosure; and

FIG. 45 is a block diagram of a computing system that may be used for implementing the devices and methods disclosed herein.

Corresponding numerals and symbols in the different figures generally refer to corresponding parts unless otherwise indicated. The figures. are drawn to clearly illustrate the relevant aspects of the embodiments and are not necessarily drawn to scale.

### DETAILED DESCRIPTION

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Various embodiments of communication systems will now be presented with reference to various apparatuses and methods. These apparatuses and methods will be described in the following detailed description and illustrated in the accompanying drawings by various blocks, modules, components, circuits, steps, processes, algorithms, or the like (collectively referred to as “elements”). These elements maybe implemented using hardware, software, or combinations thereof. Whether such elements are implemented as hardware or software depends upon the particular application and design constraints imposed on the overall system.

Disclosed herein are methods, systems, and apparatus for resource efficient signaling to a LP-WUR. Also disclosed herein are methods, systems, and apparatus for efficient support of in-band selectivity and high data for LP-WURs.

In various embodiments, a method implemented in a wireless device includes receiving a low-power wake-up signal (LP-WUS) configuration from a network side device, the LP-WUS configuration indicating a set of frequency resources allocated for LP-WUS transmission. The method also includes determining one or more subsets of the set of frequency resources to be allocated to one or more bits associated with the LP-WUS transmission according to the LP-WUS configuration and determining a first reference signal and a second reference signal according to the LP-WUS configuration. The method also includes receiving one or more signals over the set of frequency resources from the network side device. The method also includes determining one or more signal levels according to the one or more signals and determining the one or more bits according to the one or more signal levels, the first reference signal, and the second reference signal.

Some embodiments of the disclosure provide that the determining the one or more bits according to the one or more signal levels, the first reference signal, and the second reference signal includes determining a relative difference with respect to the first reference signal and the second reference signal. Some embodiments of the disclosure provide that the first reference signal includes a first intensity or threshold representing a bit “0”, wherein the second reference signal comprises a second intensity or threshold representing a bit “1”, and wherein the determining the one or more bits according to the one or more signal levels, the first reference signal, and the second reference signal includes decoding a first bit of the one or more bits to be a “1” when a difference between a first one of the one or more signal levels and the first reference signal is less than a difference between the first one of the one or more signal levels and the second reference signal. Some embodiments of the disclosure provide that the first reference signal includes a first intensity or threshold representing a bit “0”, wherein the second reference signal includes a second intensity or threshold representing a bit “1”, and wherein the determining the one or more bits according to the one or more signal levels, the first reference signal, and the second reference signal includes decoding a first bit of the one or more bits to be a “0” when a difference between a first one of the one or more signal levels and the first reference signal is greater than a difference between the first one of the one or more signal levels and the second reference signal. Optionally, in some embodiments, a first bit of the one or more bits is decoded to be a “0” when a difference between a first one of the one or more signal levels and the first reference signal is equal to a difference between the first one of the one or more signal levels and the second reference signal. Optionally, in some embodiments, the first bit of the one or more bits is decoded to be a “1” when a difference between a first one of the one or more signal levels and the first reference signal is equal to a difference between the first one of the one or more signal levels and the second reference signal. Some embodiments of the disclosure provide that the method also includes passing the one or more signals through an envelope detector prior to determining one or more signal levels according to the one or more signals. In an embodiment, each of the one or more signals comprises on-off keying (OOK) modulation. Some embodiments of the disclosure provide that the LP-WUS configuration is received in a higher layer signal. Some embodiments of the disclosure provide that the LP-WUS configuration further indicates at least one of a number of bits multiplexed in an orthogonal frequency-division multiplexing (OFDM) symbol, a number of LP-WUSs multiplexed in the frequency domain, the first subset of frequency resources allocated for a null reference signal, or the second subset of frequency resources allocated for consistent reference signal. Some embodiments of the disclosure provide that the first reference signal includes a first intensity or threshold and wherein the first intensity or threshold includes an estimated noise level intensity or threshold. Some embodiments of the disclosure provide that the second reference signal includes a second intensity or threshold and wherein the second intensity or threshold includes an estimated interference power and channel fading level intensity or threshold. In an embodiment, the determining the first reference signal and the second reference signal according to the LP-WUS configuration further includes receiving at least one of the first reference signal or the second reference signal from the network device.

In various embodiments, a method implemented in a wireless transmit/receive unit (WTRU) includes receiving a low-power wake-up signal (LP-WUS) configuration, the LP-WUS configuration indicating a set of frequency resources allocated for LP-WUS transmission. The method also includes determining one or more subsets of the set of frequency resources to be allocated to one or more bits associated with the LP-WUS transmission. The method also includes determining a first intensity or threshold based on a first signal received over a first subset of frequency resources. The method also includes determining a second intensity or threshold based on a second signal received over a second subset of frequency resources. The method also includes determining one or more signal levels based on one or more signals received over the one or more subsets of the set of frequency resources. The method also includes detecting the one or more bits based on the first intensity or threshold, the second intensity or threshold, and the one or more signal levels.

In an embodiment, the LP-WUS configuration is received in a higher layer signal. In an embodiment, the LP-WUS configuration further indicates at least one of a number of bits multiplexed in an orthogonal frequency-division multiplexing (OFDM) symbol, a number of LP-WUSs multiplexed in the frequency domain, the first subset of frequency resources allocated for a null reference signal, or the second subset of frequency resources allocated for consistent reference signal. In an embodiment, the first intensity or threshold is an estimated noise level intensity or threshold. In an embodiment, the second intensity or threshold is an estimated interference power and channel fading level intensity or threshold.

In various embodiments, a method implemented in a wireless transmit/receive unit (WTRU) for wireless communications includes receiving a low-power wake-up signal (LP-WUS) configuration indicating a first type of signaling, a second type of signaling, and a reference signal configuration, wherein the WTRU includes a first power state and a second power state. The method also includes determining a received signal strength based on the reference signal configuration. The method also includes, based on a first condition on the received signal strength, operating a receiver in the first power state and monitoring signals according to the first type of signaling. The method also includes, based on a second condition on the received signal strength, operating the receiver in the second power state and monitoring the signals according to the second type of signaling.

Some embodiments of the disclosure provide that the reference signal configuration further indicates a configured signal strength intensity or threshold. In an embodiment, the first condition being the received signal strength above the configured signal strength intensity or threshold. In an embodiment, the second condition being the received signal strength below the configured signal strength intensity or threshold. Some embodiments of the disclosure provide that the LP-WUS configuration further indicates a post envelope detection (ED) center frequency and a post ED bandwidth. Some embodiments of the disclosure provide that the first power state is lower than the second power state. Some embodiments of the disclosure provide that the monitoring the signals according to the first type of signaling is based on the post-ED center frequency and the post-ED bandwidth. Some embodiments of the disclosure provide that the LP-WUS configuration further indicates one or more pre-ED center frequencies and one or more pre-ED bandwidths. Some embodiments of the disclosure provide that the monitoring the signals according to the second type of signaling is based on the one or more pre-ED center frequencies and the one or more pre-ED bandwidths. Some embodiments of the disclosure provide that a radio frequency (RF) ED LP-WUR is utilized in the first power state. Some embodiments of the disclosure provide that an intermediate frequency (IF)/baseband (BB) ED LP-WUR is utilized in the second power state. Some embodiments of the disclosure provide that the LP-WUS configuration indicating at least one of support for a post-ED signaling design, a pre-ED signal, a post-ED signal, a LP-WUS transmission data rate, or a LP-WUS coding scheme and coding rate. Some embodiments of the disclosure provide that the first condition is post-ED signaling design being supported. In an embodiment, the second condition is post-ED signaling design not being supported.

In various embodiments, a method includes transmitting, by a base station, a low-power wake-up signal (LP-WUS) that produces a signal at least a specific intermediate/center frequency (IF) after/post envelope detection (ED) for wake-up signal (WUS) message demodulation and detection in a receiver.

Some embodiments of the disclosure provide that the LP-WUS transmitted by the base station includes at least two sets of contiguous frequency resources separated by the IF. In an embodiment, the LP-WUS signal transmitted by the base station includes at least one contiguous frequency resource, and background traffic signals at frequencies are separated from the contiguous frequency resource by the specific IF.

In accordance with an embodiment, a method includes transmitting, by a base station, a low-power wake-up signal (LP-WUS) that produces a signal at least a specific intermediate/center frequency (IF) after/post envelope detection (ED) for wake-up signal (WUS) message demodulation and detection in a receiver.

In an embodiment, the LP-WUS transmitted by the base station includes at least two sets of contiguous frequency resources separated by the IF. In an embodiment, the LP-WUS signal transmitted by the base station includes at least one contiguous frequency resource, and background traffic signals at frequencies are separated from the contiguous frequency resource by the specific IF.

In accordance with an embodiment, a method implemented in a base station includes determining a low-power wake-up signal (LP-WUS) configuration for a wireless device, wherein the LP-WUS configuration comprises one or more subsets of a set of frequency resources to be allocated to one or more bits associated with the LP-WUS. The method also includes transmitting the LP-WUS configuration to the wireless device, the LP-WUS configuration indicating a set of frequency resources allocated for LP-WUS transmission. The method also includes transmitting one or more signals over the set of frequency resources to the wireless device.

In an embodiment, the one or more signals are encoded based on on-off keying (OOK) modulation. In an embodiment, the LP-WUS configuration is received in a higher layer signal. In an embodiment, the LP-WUS configuration further indicates at least one of: a number of bits multiplexed in an orthogonal frequency-division multiplexing (OFDM) symbol, or a number of LP-WUSs multiplexed in the frequency domain. In an embodiment, the LP-WUS configuration further indicates a first subset of frequency resources allocated for a null reference signal. In an embodiment, the LP-WUS configuration further indicates a second subset of frequency resources allocated for consistent reference signal. In an embodiment, the method also includes determining the one or more signal levels according to one or more bits, a first reference signal, and second reference signal, wherein a bit having a first bit value is encoded according to the first reference signal and a bit having a second bit value is encoded according to the second reference signal. In an embodiment, the first reference signal includes a first intensity representing a bit “0”, wherein the second reference signal includes a second intensity representing a bit “1”, and wherein the method also includes determining the one or more signals according to the one or more bits, the first reference signal, and the second reference signal includes: encoding a first signal of the one or more signals to have an intensity equivalent to the first reference signal when a first bit of the one or more bits is a “1”; or encoding the first signal of the one or more signals to have an intensity equivalent to the second reference signal when the first bit of the one or more bits is a “0”. In an embodiment, the method also includes transmitting at least one of a first reference signal or a second reference signal to the wireless device.

In various embodiments, a wireless transmit/receive unit (WTRU), includes at least one processor and a non-transitory computer readable storage medium storing programming, the programming including instructions that, when executed by the at least one processor, cause the WTRU to perform any of the methods disclosed above.

In various embodiments, a base station includes at least one processor and a non-transitory computer readable storage medium storing programming, the programming including instructions that, when executed by the at least one processor, cause the base station to perform any of the methods disclosed above.

In various embodiments, an apparatus includes at least one processor; and a non-transitory memory storing programming instructions that, when executed by the at least one processor, cause the system to perform any of the methods described above.

In various embodiments, a non-transitory computer readable storage medium includes instructions that when executed by a processor cause the processor to perform any of the methods described above.

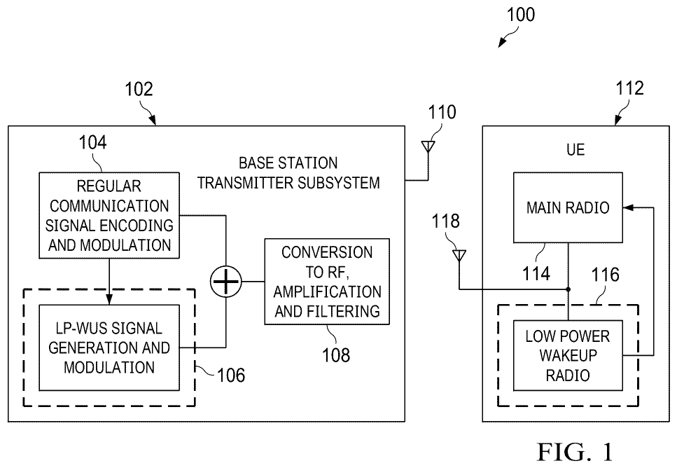

FIG. 1 shows a wireless system 100 for low power wakeup signaling in accordance with an embodiment. System 100 is an example of a system that may be utilized to implement the disclosed methods. System 100 includes a base station transmitter subsystem 102 and a UE 112. The base station transmitter subsystem 102 includes a regular communication signal encoding and modulation unit 104, a LP-WUS signal generation and modulation unit 106, a conversion to RF amplification and filtering unit 108, and an antenna 110 for transmitting and receiving signals. UE 112 includes a main radio 114, a low power wakeup radio 116, and an antenna 118 for transmitting and receiving signals. Low power wakeup radio 116 is used to support sleep mode operation of UE 112. This may be particularly useful for Internet of Things (IoT) devices. When the UE 112 is in sleep mode, the main radio 114 is shut down to reduce power consumption. The low power wakeup radio 116 monitors the over-the-air signal for LP-WUS from the base station transmitter subsystem 102. Once the low power wakeup radio 116 detects the LP-WUS, it sends a control signal to wake up the main radio 114 for communication. The base station transmitter subsystem 102 generates the LP-WUS by the LP-WUS signal generation and modulation unit 106 and then transmits the LP-WUS, in addition to a regular communication signal generated by the regular communication signal encoding and modulation unit 104, to the UE 112 to wake up the UE 112 that is in sleep mode so that the UE 112 can communicate with the base station transmitter subsystem 102.

In 3GPP, duty-cycled operations in the form of Discontinuous Reception (DRX) and extended Discontinuous Reception (eDRX) are defined for power consumption reduction in NR RRC_IDLE and RRC_INACTIVE states through the reduction of the number of Paging Occasions (POs) monitored by the UE. Further power consumption reduction is achieved through Paging Early Indication (PEI) in NR RRC_IDLE and RRC_INACTIVE states, which is still subject to the duty-cycled operation. Similar power saving techniques are defined for NR RRC_CONNECTED state in the form of connected mode DRX (C-DRX) and Wake-Up Signal (WUS). Both PEI and WUS can be received by UEs as DCIs over the PDCCH.

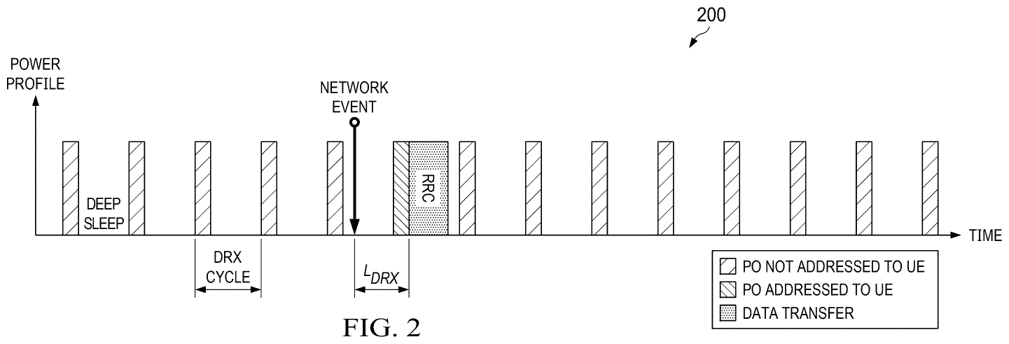

FIG. 2 shows an example Protocol plow/timeline 200 based on DRX configuration in accordance with an embodiment. For a UE using DRX in RRC_IDLE or RRC_INACTIVE states, it monitors one PEI occasion (PEI-O) and/or one PO per DRX cycle as shown in FIG. 2, based on PEI configuration, where a PEI-O/PO consists of a set of PDCCH monitoring occasions (MOs) and can consist of multiple time slots. The UE initiates RRC Connection Establishment or RRC Connection Resume procedures upon reception of a CN initiated or RAN initiated paging, respectively. If PEI is configured, the UE monitors an associated PO in a DRX cycle only if the PEI is detected and the UE's corresponding subgroup is indicated in the PEI.

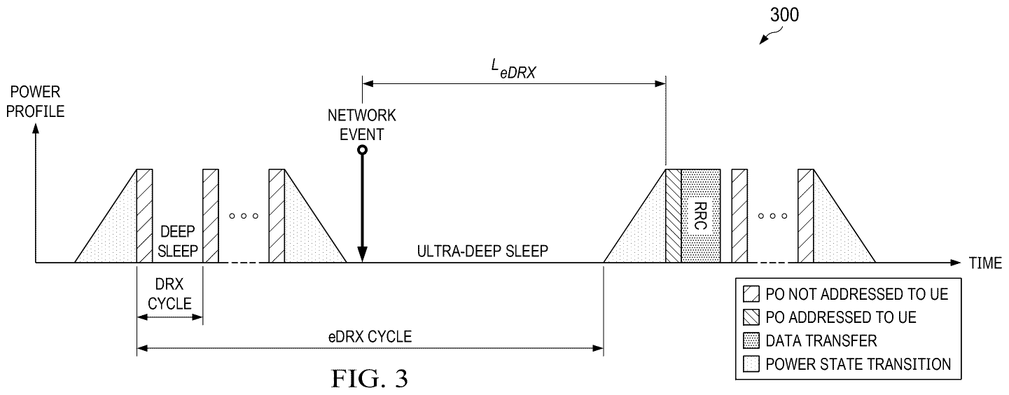

FIG. 3 shows an example protocol flow/timeline 300 based on eDRX (T_{eDRX}>1024 frame) configuration in accordance with an embodiment. For a UE using eDRX in RRC_IDLE or RRC_INACTIVE states, it monitors one PEI-O and/or one PO per eDRX cycle, based on PEI configuration, as shown in FIG. 2 if the configured eDRX cycle is no longer than 1024 radio frames. Otherwise, the UE monitors one PEI-O and/or one PO per eDRX cycle, based on PEI configuration, according to a configured DRX cycle during a UE-specific and periodic Paging Time Window (PTW), where the PTW period is determined by the eDRX cycle and the length is configured by upper layers, as shown in FIG. 3. The UE initiates RRC Connection Establishment or RRC Connection Resume procedures upon reception of a CN initiated or RAN initiated paging, respectively. If PEI is configured, the UE monitors an associated PO in a DRX/eDRX cycle only if the PEI is detected and the UE's corresponding subgroup is indicated in the PEI.

The DRX, eDRX, and C-DRX can provide higher power saving gain by increasing the duty cycle duration at the expense of higher latency to be expected by the UE. PEI and WUS can provide more power saving gain without an impact on latency, but the gain is limited by the power consumption required to decode a DCI over PDCCH. A new WUS that can be received with significantly lower power consumption than existing PEI/WUS designs may enable new trade-off regions of Latency versus Power but will require a dedicated Low-Power Wake-Up Radio/Receiver (LP-WUR) with a simple architecture as discussed next.

The idea behind power saving using the LP-WUR is to let the main radio (MR), which can consume significant amount of power in range mWs, stay in a sleep power state for as long as possible and have the LP-WUR, which should consume 2-3 orders of magnitude less power than the MR, monitor for a LP-WUS that acts as a trigger for the MR to wake-up. There are two options for how the LP-WUR may monitor a LP-WUS and the following terminology can be used interchangeably to identify each option:
Option 1: “Continuous” and “Always-on” monitoring
Option 2: “Discontinuous”, “Periodic”, and “Duty-Cycled” monitoring

Further, there may be three different options for the behavior of a UE in response to the reception of a LP-WUS depending on the content of the LP-WUS and network configuration. The three UE behavior options, which may be applicable to both LP-WUS monitoring “Option 1” and “Option 2”, are:
UE_Behavior (1): LP-WUS carries a UE ID and MR is not required to monitor POs.
UE_Behavior (2): LP-WUS carries a UE ID and/or a UE group ID, and MR is required to monitor legacy POs/PFs.
UE_Behavior (3): LP-WUS carries a UE ID and/or a UE group ID, and MR is required to monitor newly defined POs/PFs.

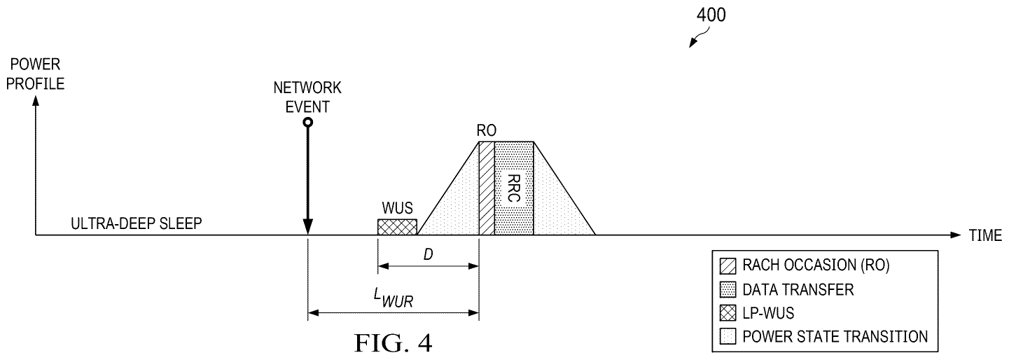

FIG. 4 shows An Example Protocol Flow/Timeline 400 based on LP-WUS Configuration with UE Addressing in accordance with an embodiment. UE_Behavior (1), as shown in FIG. 4, may result in the best experienced latency under LP-WUS power saving scheme, especially when continuous monitoring mode (Option 1) is used. This is due to the fact that the UE may wake-up the main radio to directly initiate RRC Connection Establishment or RRC Connection Resume procedures upon reception of a CN initiated or RAN initiated paging, respectively, as indicated by the LP-WUS. This UE behavior also eliminates the need to align the LP-WUR and MR duty cycles when periodic LP-WUS monitoring is considered. However, this comes at the cost of a large LP-WUS payload size and subsequently a potentially high resource overhead requirement.

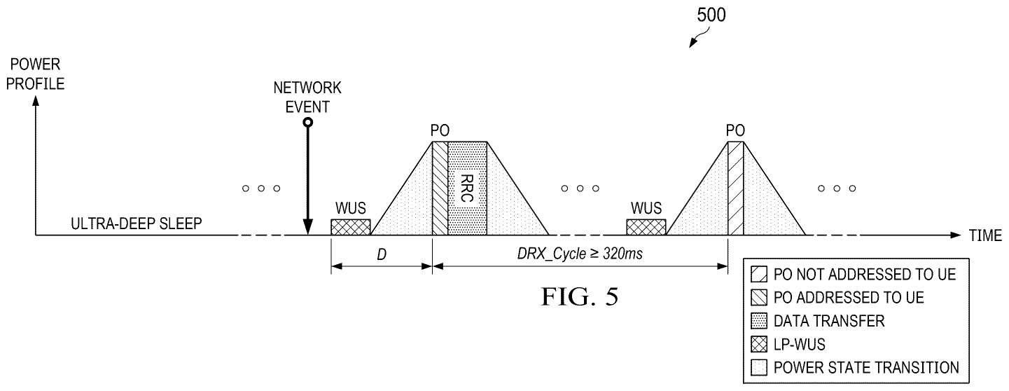

FIG. 5 shows an example protocol flow/timeline 500 based on LP-WUS configuration with UE group addressing in accordance with an embodiment. UE_Behavior (2), as shown in FIG. 5, will result in a LP-WUS latency performance that is limited by the legacy DRX cycle, i.e., {0.32, 0.64, 1.28, 2.56}seconds, and will always underperform the DRX power saving scheme, with the same DRX cycle configuration, in terms of latency. This is due to the fact that the UE will still have to monitor POs using the MR upon wake up in response to the detection of a LP-WUS. However, power saving gain is still expected compared to DRX, i.e., depending on the UE group size, and managed LP-WUS resource overhead is possible due to the potential of using UE group IDs instead of UE unique IDs. Compared to UE_Behavior (1) and based on the UE group size, i.e., when UE group IDs are considered for UE_Behavior (2), there may be a power consumption penalty that may limit any power saving gain considering the MR's expected high transition energy from ‘Ultra-deep sleep’ power state. Further, considering ‘always-on’ monitoring of the LP-WUS under UE_Behavior (2) when the LP-WUS is carrying UE group ID(s) may not result in any latency reduction benefit compared to DRX power saving scheme since the MR will still have to monitor POs according to any of the legacy DRX cycles. However, ‘always-on’ monitoring mode may alleviate the need for the LP-WUR to periodically synchronize with the transmitting entities.

UE_Behavior (3) may correspond to the definition of shorter RRC IDLE/INACTIVE state DRX cycles, i.e., <320 ms, which may result in a better LP-WUS latency performance compared to UE_Behavior (2) without any impact on power consumption due to the use of LP-WUR and at a managed LP-WUS resource overhead due to the use of UE group IDs.

Both UE_Behavior (2) and (3) may also apply for the case when the LP-WUS carries a unique UE ID but the MR is still required to monitor POs. However, for a LP-WUS with a considerably low false alarm rate (FAR), it might be unreasonable to mandate MR monitoring of POs after detection of LP-WUS carrying a unique UE ID. That is because PO monitoring by the MR will add to the power consumption without providing any additional information to the UE.

### Low-Power Receiver Architectures

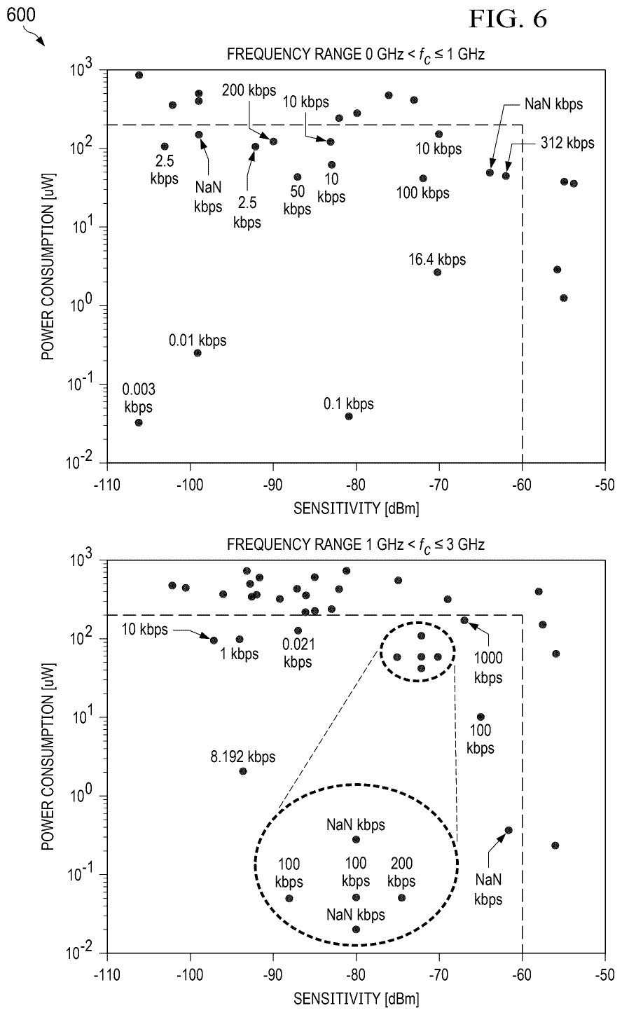

FIG. 6 shows a survey of Low-Power Receiver Architectures 600 in accordance with an embodiment. A dedicated low-power receiver, LP-WUR, is proposed as a supplement to a MR of a UE to alleviate the power consumption associated with the current need of UEs to periodically wake up once per DRX cycle to monitor PDCCH. FIG. 6 shows the trade-offs between receiver power consumption, sensitivity, and supported data rate for two carrier frequency ranges, f_{c}≤1 GHz and 1 GHz<f_{c}≤3 GHz. The FIG. 6 suggests that receiver architectures consuming power of 40 μW<P_{c}≤140 μW can support sensitivity levels −97 dBm<Pₘᵢₙ≤−70 dBm at data rates 10 kbps≤R<200 kbps using non-coherent OOK modulation. In the following sections, a few of those receiver architectures are examined. In general, examined low-power receiver architectures can be categorized as mixer-first architectures, such as the uncertain-IF, the sub-sampling, and the dual uncertain-IF architectures; and envelope detection first architectures, such as the double-sampling and the 2-tone reception architectures. Below, a couple of low-power receiver architectures that are suitable for FSK modulation are presented.

The 3GPP standards specify the modulation formats of signals. For example, the resource elements (REs) within physical resource blocks on to which control channels and shared channels are often modulated with binary phased shift keying (BPSK), quadrature phase shift keying (QPSK)/4-QAM (quadrature amplitude modulation), 16-QAM, 64-QAM, and possible 256-QAM. There are also references signals on REs which can have a Zadoff-Chu modulation. The REs can be transformed in a waveform using a (inverse) fast Fourier transform (FFT) and/or a discrete Fourier transform (DFT) before transmission. With the introduction of a wakeup receiver, a second modulation format different than described above can be used to generate a wakeup-signal. Examples of the second modulation format can include frequency shift keying (FSK) and on-off keying (OOK).

The network can provide (transmit) a wireless device with a configuration of the wake-up signal. This configuration can include parameters, such as whether OOK or FSK is used, the bandwidth, data rate, symbol rate, etc. When the mobile device enables use of the WUR, the WUR is then monitoring for the WUS (first modulation format). The mobile device is no longer monitoring for the modulation formats (second modulation format) used for reference signals, control channels, shared channels. Upon detection of the WUS, the mobile device starts monitoring for the modulation formats used for reference signals, control channels, and shared channels for a configurable duration. For example, it may set a timer. Upon expiry of the timer (or after the duration), the wireless device can resume monitoring for the WUS if it did not receive any control/shared channel associated with the wireless device. The association can include a RNTI.

### ASK Receiver Architectures

In this section, Amplitude Shift Keying (ASK), e.g., OOK, receiver architectures are discussed in the context of the types identified in 3GPP RAN1 discussions, i.e., RF envelope detection and IF/BB envelope detection architectures.

### RF Envelope Detection (ED)

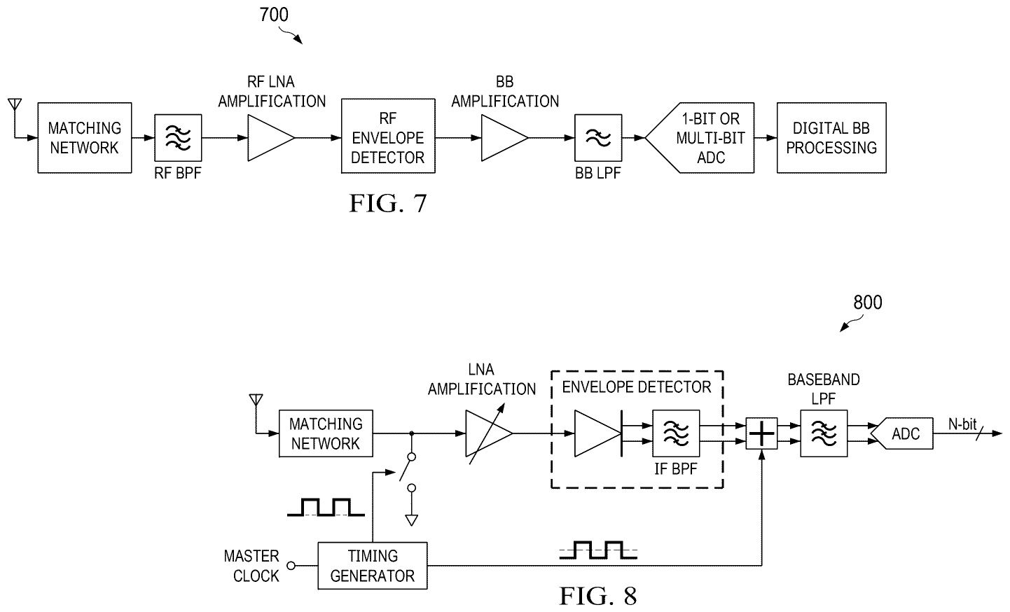

FIG. 7 shows a basic block diagram for RF envelope detection receiver architecture 700 in accordance with an embodiment. A basic block diagram for RF envelope detection is described in RAN1 #110 bis-e and is shown in FIG. 7. The RF signal is converted directly into baseband using the RF envelope detector eliminating the need for LOs or Phase-Locked Loops (PLLs). Signal digitization for digital baseband processing can be performed using a 1-bit or multi-bit ADC. The RF Low Noise Amplifier (LNA) and/or BB Amplifier (AMP) can be optionally considered. For this architecture, high-Q matching networks and/or RF BPF are considered to suppress adjacent channel interference or interference from legacy NR signal and/or other LP-WUS on adjacent subcarriers.

FIG. 8 shows an example of synchronized switching/double-sampling receiver architecture 800 in accordance with an embodiment. The, originally termed, double-sampling architecture is another architecture that attempts to reduce the power consumption overhead associated with the FE PLLs through the utilization of low-frequency oscillators that are 1 to 2 orders of magnitude below target RF frequency. The architecture also mitigates the impact of the 1/f (flicker) noise through the combination of the chopping/switching stage at RF, double-sampling/switching stage at IF, and utilization of a clock frequency above the flicker noise corner frequency. An example double-sampling architecture is shown in FIG. 8 where the IF BPF stage may be followed by an amplification stage. Since RF envelope detection is utilized in this architecture, receiver selectivity is mainly controlled by the RF FE filters.

Sometimes, FE selectivity is compromised, i.e., a −3 dB bandwidth of 21 MHz/59 MHz in the 915 MHz/2.4 GHz band, for the low power consumption of ˜51 μW and the receiver architecture achieves a sensitivity of −75 dBm/−80 dBm using a data rate of 100 kbps/10 kbps in the 915 MHz band. In some embodiments the receiver architecture provides a FE −3 dB bandwidth of 110 MHz, that is determined by the LNA and the input matching network, and achieves a sensitivity of −86.5 dBm/−61 dBm using a data rate of 10 kbps for a power consumption of 146 μW/64 μW in the 780-950 MHz bands (a data rate of 100 kbps is supported at ˜5 dB degradation in sensitivity). However, the receiver selectivity may be improved to a −3 dB bandwidth of only 13 MHz using a high-Q RF SAW filter at the expense of a ˜2 dB degradation in sensitivity. Further power consumption reduction for some receiver architectures may be achieved by discarding LNAs at RF at the expense of further degradation in receiver sensitivity.

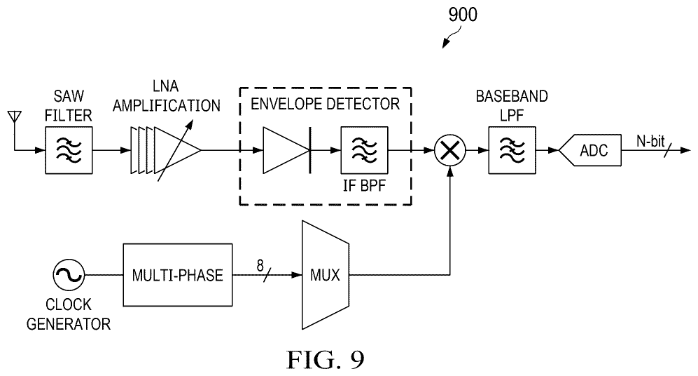

FIG. 9 shows an example of a 2-Tone reception envelope detection receiver architecture 900 in accordance with an embodiment. Like the double-sampling architecture, the architecture shown in FIG. 9 utilizes RF envelope detection and low-frequency oscillators for power consumption reduction. However, instead of the utilized switching/chopping technique in the double-sampling architecture, i.e., multiplying the received RF signal with a square wave of low frequency, some architectures use a 2-tone transmission scheme. Further, the architecture treats the double-sampling/switching stage at IF, i.e., after envelope detection, as a mixing stage and utilizes a FE SAW filter to improve the receiver's interference rejection capability.

The specific signal design where a 2-tone transmission scheme is considered allows the use of BPSK-IF as a modulation scheme for a non-coherent envelope detection-based receiver architecture. It also improves the receiver selectivity for better in-band interference rejection. Some architectures, therefore, manage out-of-band interference rejection through the SAW filter and in-band interference rejection through signal design and IF BPF after envelope detection. It achieves a sensitivity of −83 dBm/−56 dBm using a data rate of 10 kbps for a power consumption of −121 μW/63.5 μW (+10 μW for IF clock generation) in the 915 MHz band. The sensitivity of this architecture is similar to some double-sampling architectures when accounting for the losses due to the SAW filter. However, it provides a much better interference rejection than the double-sampling architecture as it can tolerate between −19 dB to −10.5 dB of in-band carrier-to-interference ratio (CIR) at +1 MHz offset from each tone based on power consumption.

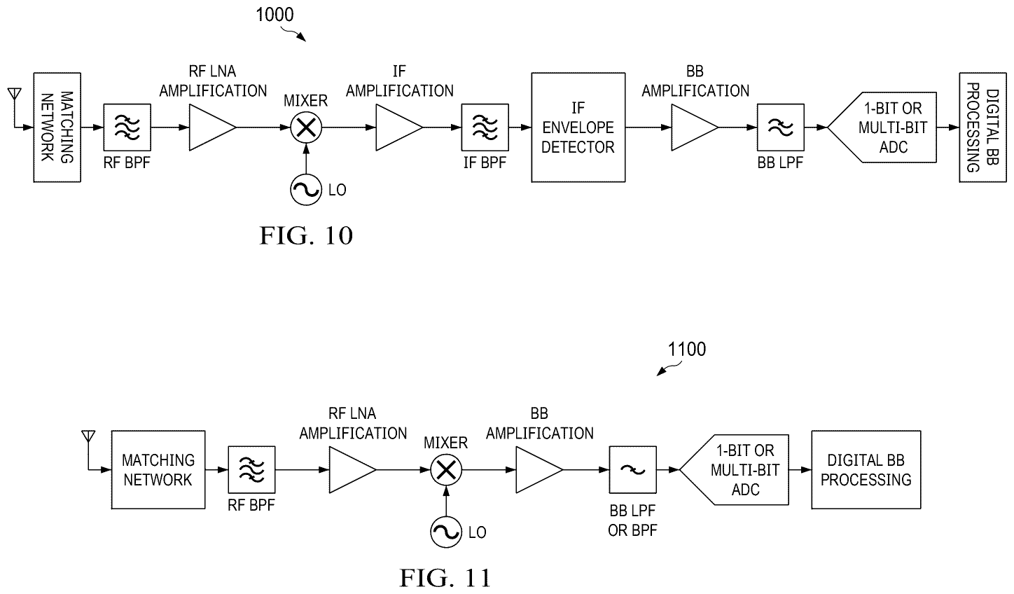

Basic block diagrams for IF and BB envelope detection are described in RAN1 #110 bis-e and are shown in FIG. 10 and FIG. 11, respectively. FIG. 10 shows a basic block diagram for IF envelope detection receiver architecture 1000 in accordance with an embodiment. FIG. 11 shows a basic block diagram for BB envelope detection receiver architecture 1100 in accordance with an embodiment. In IF envelope detection (FIG. 10), the RF signal is first converted to an IF signal using an LO and an RF mixer, and then the IF signal is converted to a BB signal using the IF envelope detector. In this architecture, low power consumption is achieved by relaxing the accuracy and stability requirements of the LO. Signal digitization for digital baseband processing can be performed using a 1-bit or multi-bit ADC. The RF Low Noise Amplifier (LNA) and/or IF AMP and/or BB AMP can be optionally considered. For this architecture, high-Q matching networks and/or RF BPF and/or IF BPF are considered to suppress adjacent channel interference or interference from legacy NR signal and/or other LP-WUS on adjacent subcarriers. Further, an image rejection filter or an image rejection mixer is required. On the other hand, the RF signal in the BB envelope detection architecture (FIG. 11) is directly converted to BB signal using an LO and an RF mixer. A high-Q matching networks and/or an RF BPF and/or a BB BPF/LPF are considered to suppress adjacent channel interference or interference from legacy NR signal and/or other LP-WUS on adjacent subcarriers. Further, an image rejection filter is not required.

Like the double-sampling architecture, the sub-sampling architecture attempts to reduce the power consumption overhead associated with the FE PLLs through the utilization of low-frequency oscillators that are 1 to 2 orders of magnitude below target RF frequency. However, instead of the utilized switching/chopping technique in the double-sampling architecture, i.e., multiplying the received RF signal with a square wave of low frequency, some sub-sampling architectures use the low frequency clock to sub-sample the received RF signal and generate a signal at IF. Further, some receiver architectures utilize the uncertain IF topology, i.e., utilizes a low-power and low-accuracy reference clock, but improves receiver selectivity through the utilization of a period-based calibration circuit.

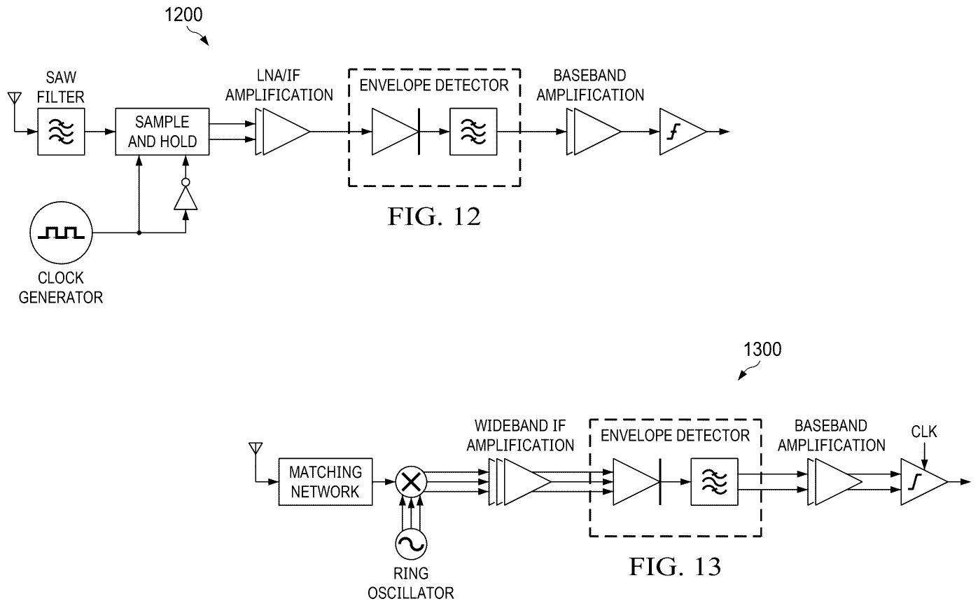

FIG. 12 shows an example of sub-sampling receiver architecture 1200 in accordance with an embodiment. In the example sub-sampling architecture shown in FIG. 12, the receiver selectivity is determined by a SAW filter and a two active-inductor based amplifier stages providing ˜13 MHz of bandwidth. Some architectures similar to that shown in FIG. 12 achieve a sensitivity of −75 dBm using a Manchester encoded data rate of 200 kbps for a power consumption of ˜22.9 μW (calibration circuit may on average consume 0.3 μW for 1 ms per 100 ms calibration) in the 915 MHz band.

FIG. 13 shows an example of uncertain IF receiver architecture 1300 in accordance with an embodiment. The uncertain IF architecture 1300 is one of the architectures that attempts to reduce or eliminate the power consumption overhead associated with the front-end (FE) Phase Locked Loops (PLLs) and Low Noise Amplifiers (LNAs). This is achieved through the utilization of (1) a low-power and low-accuracy unlocked local oscillators (LOs) such as the ring oscillators, and (2) LNAs at IF instead of RF. The power consumption overhead associated with LNAs can further be eliminated by entirely discarding LNAs from the architecture at the expense of receiver sensitivity. An example uncertain IF architecture 1300 is shown in FIG. 13 where receiver selectivity, i.e., blockers elimination, is achieved through the utilization of passive high-Q front-end filters with additional filtering after the mixer, which is easier provided at lower frequencies. The architecture 1300 provides a −3 dB bandwidth of 54 MHz through RF filtering while the IF bandwidth is limited by the utilized ring oscillator uncertainty.

Therefore, in this architecture, sensitivity is limited, in general, by the integrated noise presented by the wide IF bandwidth required to deal with the LO uncertainty. In architectures similar to architecture 1300, a sensitivity of −88 dBm for 10⁻³ BER is achieved using a Manchester encoded (information bits are encoded as transitions from low-to-high or high-to-low signal levels) data rate of 250 kbps at a power consumption of ˜50 μW in the 2.45 GHz band.

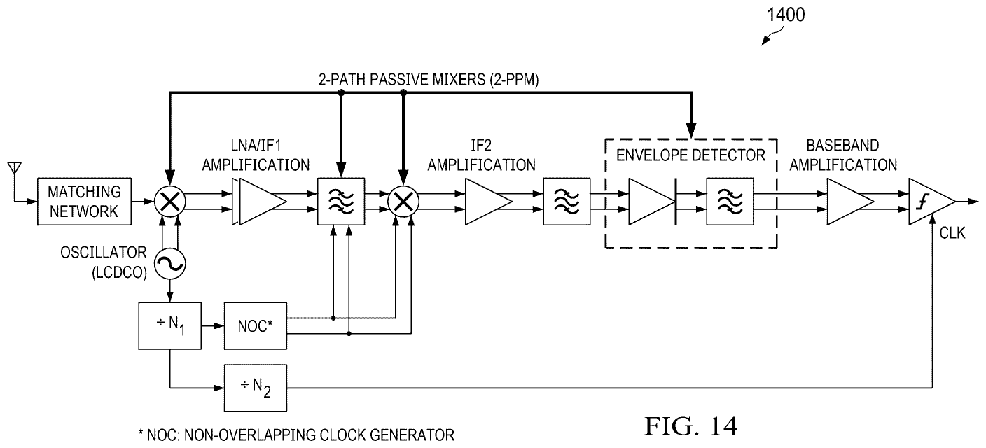

FIG. 14 shows a representation of the dual uncertain-IF receiver architecture 1400 in accordance with an embodiment. The dual uncertain-IF receiver architecture 1400, represented in FIG. 14, reuses the uncertain-IF receiver architecture to reduce power consumption while improving the receiver's selectivity by combining an unlocked low-Q resonator-referred LO (LC-DCO), where LC-DCO provides more accuracy than ring oscillators at the cost of a slight increase in power consumption, and distributed multi-stage high-Q N-path passive mixer (N-PPM) filtering technique.

The dual uncertain-IF architecture selectivity is then provided by two main narrow band-pass filtering stages, one at each of the two IF frequencies, enabling a tolerance of in-band carrier-to-interference ratio (CIR) between −25 dB to −22 dB at ±3 MHz offset. The FE matching network and RF passive mixer provide an effective bandwidth of 20 MHz while the first IF passive mixer provides an effective bandwidth of 1 MHz. The architecture achieves a sensitivity of −97 dBm/−92 dBm using a data rate of 10 kbps/50 kbps for a power consumption of ˜99 μW in the 2.4 GHz band.

Envelope detection in the dual uncertain-IF architecture utilizes the high linearity response of the N-PPM to perform direct down-conversion of the signal from the second IF frequency to DC, ensuring bandwidth reduction and removal of the LO uncertainty effects.

### FSK Receiver Architectures

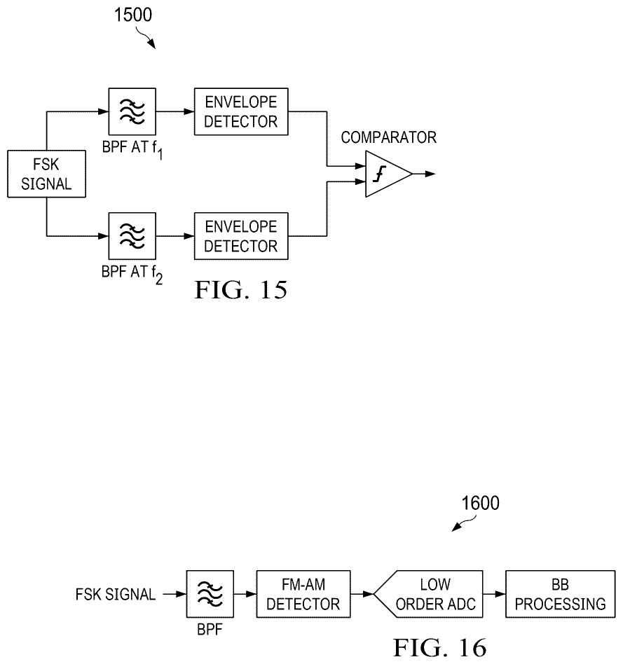

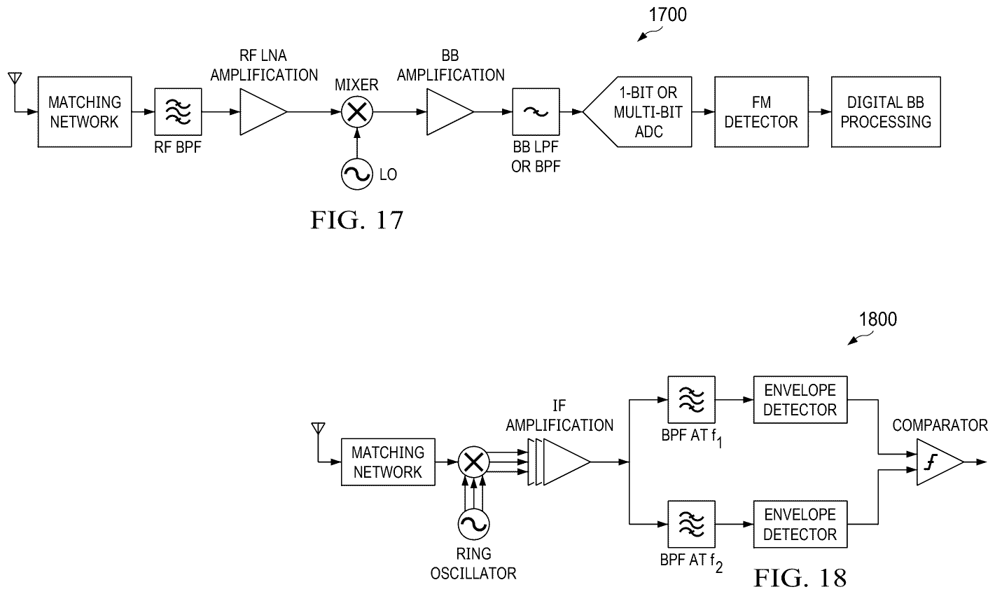

FIG. 15 is an example 1-bit FSK receiver architecture 1500 utilizing parallel OOK receivers in accordance with an embodiment. FIG. 16 shows an example FSK receiver architecture 1600 utilizing analog domain FM-to-AM detector in accordance with an embodiment. FIG. 17 shows an example FSK receiver architecture 1700 utilizing analog domain FM-to-AM detector in accordance with an embodiment. Low power receiver architectures that can support FSK modulation are also being discussed in 3GPP RAN1 as part of the LP-WUS study item. Two example architectures have been considered so far, the first example (parallel OOK receivers) reuses the OOK receiver architectures whereas the second example utilizes an FM-to-AM detector. An example architecture for a 1-bit FSK (2-FSK) receiver is shown in FIG. 15 based on the parallel OOK receivers example where each of the envelope detectors can be implemented using any of the OOK receiver architectures. On the other hand, two alternative implementations are possible for FM-to-AM detector based FSK receivers. In one implementation, the FM-to-AM detector is implemented in the analog domain, as shown in the example in FIG. 16, whereas the FM-to-AM detector is implemented in the digital domain for the second implementation, as shown in the example in FIG. 17.

For the example architecture shown in FIG. 15, a signal transmitted using frequency resource f₁ may be used to indicate a transmitted bit 0, and a signal transmitted using frequency resource f₂ may be used to indicate a transmitted bit 1. The received FSK signal is then passed into two bandpass filters centered at f₁ and f₂, respectively, into the envelope detector circuits. The output from the envelope detectors is then fed into a comparator to decide on whether a bit 0 or bit 1 is transmitted.

Note that the FSK receiver, as shown in FIG. 15, may be based on RF envelope detector receiver architectures. Therefore, the two bandpass filters may be RF filters which can be costly and/or bulky make the architecture unattractive for implementation. Alternatively, an IF envelope detection-based receiver architectures maybe utilized to avoid the costly and/or bulky implementations. FIG. 18 shows an example 1-bit FSK (2-FSK) receiver 1800 using the IF envelope detection-based receiver architecture in accordance with an embodiment. As mentioned above, in order to reduce power consumption of IF envelope detection architecture, a low accuracy and stability LO, e.g., a ring oscillator, may be used. The LO's low accuracy, e.g., ±200 ppm, can result in a frequency offset of ±400 kHz at a carrier frequency of 2 GHz. Such a frequency offset may require guard bands of comparable bandwidths to avoid/mitigate interference which may subsequently result in an increase in the required frequency resources for such an architecture.

### Section 4

One benefit of various disclosed embodiments is to reduce the number of non-contiguous frequency resources that enables the same number of bits/symbols to be transmitted on a single OFDM symbol. Following are signal, e.g., LP-WUS, designs that target the low power receiver architectures disclosed herein while relaxing the frontend RF filters' design and/or guard band requirements.

### Signal Design

In this section, In-band Selectivity Aware LP-WUS Designs are described in while the feasibility and benefits of those designs for mixer-first receiver architectures, i.e., IF/BB envelope detection architectures, are discussed in further below.

### Dual-Spectrum Allocation

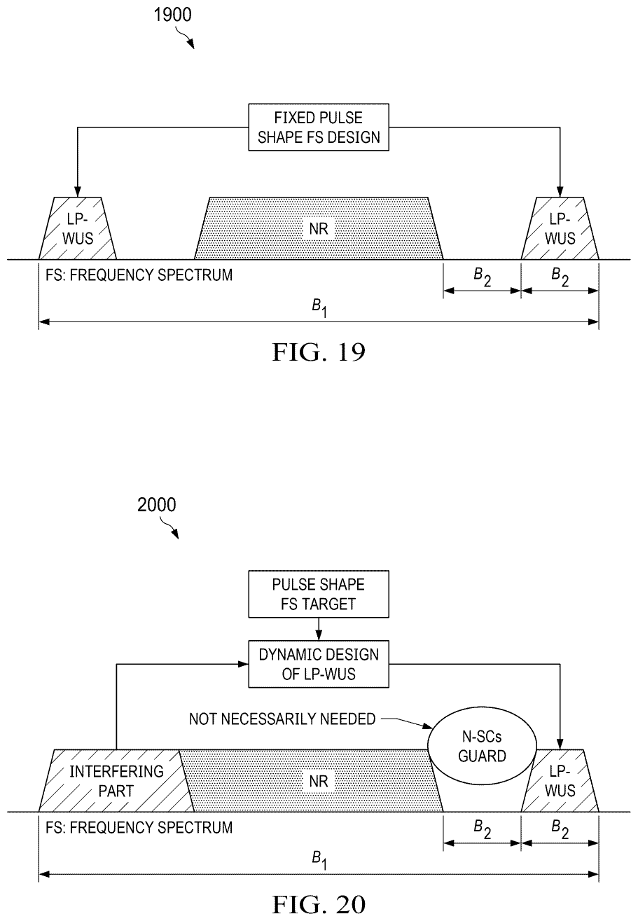

A dual-spectrum allocation scheme, as shown in FIG. 19, can be considered for RF envelope detection architectures to aid in interference suppression. In this scheme, LP-WUS frequency resources are allocated at the two edges of the channel with unallocated resources, i.e., guard bands, between the LP-WUS resources and resources allocated to any other signal. Such an allocation scheme enables a fixed and in-band selectivity aware signal design. Since RF signals, x(t), in RF envelope detection architectures are converted into baseband signals directly via the non-linear operation, e.g., self-mixing x(t)×x*(t), of RF envelope detector, the resulting spectrum of the baseband signal is [symbol] [x(t)]⊗ [symbol] [x*(t)]=X(f)⊗Q X*(−f) which is equivalent to the autocorrelation of the RF signals' spectrum, where (·)* is the conjugation operation, [symbol] [·] is the Fourier transform operation, and ⊗ is the convolution operation. Then, using the fixed dual-spectrum allocation signal design, the LP-WUS can be extracted in the baseband of the WUR as the signal centered at a known/fixed frequency (based on design of LP-WUS and guard bands at RF) of, e.g., B₁−B₂, and have a passband bandwidth of, e.g., ≈2B₂, where B₁ is the channel RF bandwidth and B₂ is the LP-WUS RF bandwidth.

FIG. 19 shows an example frequency response 1900 of a single OFDM symbol under LP-WUS dual-spectrum allocation.

With this frequency resource allocation, the existing NR signals or any interfering signals falling within the spectrum occupied by the NR signals do not produce baseband envelope signals at the frequencies of the desired signal, therefore do not interfere with the reception of the desired signal, thus achieving in-band selectivity. It is noted that while the dual-spectrum allocation scheme can solve the in-band selectivity problem, i.e., suppression of interference from signals on adjacent subcarriers, it requires sufficient guard bands around frequency resources allocated to LP-WUS. Therefore, the dual-spectrum allocation scheme might not be a spectrally-efficient solution, but it can be suitable for use when LP-WUS is expected to share the channel only with low resource utilization signals/transmissions such as SSB enabling a simple and fixed LP-WUS design. Further, this solution can be used for both OFDM-OOK and DFT-OOK.

### Synergistically (Dynamically) Generated IF-Envelope

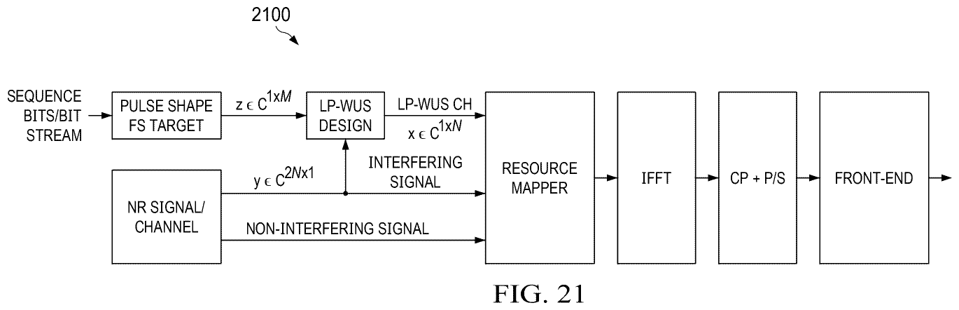

As opposed to the dual-spectrum allocation scheme with fixed LP-WUS design, another scheme can consider only single contiguous spectrum allocation to LP-WUS at one of the channel edges. However, the LP-WUS generated to occupy that spectrum is dynamically designed to account for the interfering signal, i.e., due to envelope detection operation, occupying the other edge of the channel as exemplified in FIG. 20. An exemplary OFDM-based transmitter architecture that can be used to generate the Synergistically/dynamically designed LP-WUS is shown in FIG. 21.

FIG. 20 shows an example frequency response 2000 of a single OFDM symbol under LP-WUS dynamic design with single-spectrum allocation.

In the exemplary transmitter architecture shown in FIG. 21, part of the NR signals/channels, i.e., to be multiplexed with the LP-WUS signal, is determined to be an interfering signal (y∈ [symbol] ^{2N×1}) with the LP-WUS which, in this example, is assumed to occupy 2N subcarriers based on the target design of frequency resources to be occupied by the LP-WUS after envelope detection for the RF envelope detection receiver architecture. Further in the exemplary architecture, the LP-WUS bits are used to trigger waveform selection (z∈ [symbol] ^{1×M}), i.e., target frequency spectrum of the ON or OFF state pulse shapes for OOK modulation using OFDM-OOK, every OFDM symbol. Note that the vector z can also represent the frequency spectrum of an OOK bit stream which can be obtained using DFT to support DFT-OOK. The target waveform, z, and interfering signal, y, can then be used to dynamically design the LP-WUS (x∈ [symbol] ^{1×N}) which is allocated N subcarriers. In an exemplary design, the LP-WUS can be obtained as

$${x}^{†} = {( {YY}^{†} )}^{- 1} {Yz}^{†}$$

where the matrix Y∈ [symbol] ^{N×M} is formulated as Y=[y_{N-1} y_{N-2} . . . y_{N-M}]* such that yᵢ∈ [symbol] ^{N×1} is a shifted version of y with l preceding 0's and N+l truncated elements; and (·)^{†} performs the conjugate transpose operation. In order to have a reliable design of x, the following constraint on M should be satisfied, i.e., M≤N. This constraint ensures that there are sufficient degrees of freedom to find an exact solution of x. Note that in the example shown in FIG. 20, a number N of subcarriers (SCs) are considered as a guard band. However, in an alternative example, the N-SCs used as guard band in FIG. 20 can be considered as part of the LP-WUS such that the length of the LP-WUS x∈ [symbol] ^{1×2N} and M can be selected to satisfy, e.g., M≤2N.

It is worth noting that this algorithm can easily support modulations other than OOK, such as BPSK, QPSK, QAM, OFDM, multiple parallel OOK channels, etc., by simply setting the target waveform vector z to the DFT of the desired modulation symbols. It is also worth noting that compared to the scheme presented in above, this scheme provides savings in the required frequency resources to be occupied solely by the LP-WUS, e.g., LP-WUS only requires the frequency resources on one edge of the carrier allowing rest of the spectrum to be occupied by information/data intended for other UEs. However, it should be noted that the network can revert back to the dual-spectrum allocation scheme if the amount of available information/data intended for other UEs are not sufficient to occupy the rest of the spectrum, i.e., not allocated to LP-WUS, and are scheduled in frequency resources other than those needed by the LP-WUS to generate desired signal at a fixed IF frequency after envelope detection at the receiver.

FIG. 21 shows an example OFDM-based transmitter architecture 2100 enabling LP-WUS dynamic design with single-spectrum allocation.

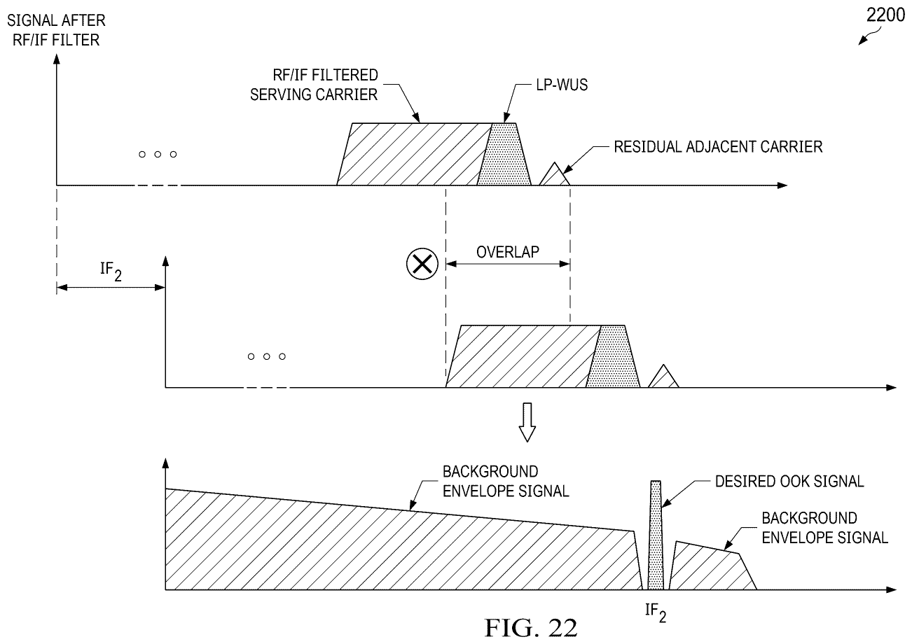

In FIG. 22, an illustration of the impact of envelope detection operation, which applies to both RF and IF envelope detection, on the signal's frequency spectrum is presented. As discussed earlier, the envelope detection operation results in the spectrum convolving with its own complex conjugate. The integration of the product of the overlapping spectrum produces the envelope spectrum at a specific frequency offset, e.g., IF₂. The LP-WUS may then be allocated a narrow bandwidth, e.g., 2 PRBs with 360 kHz bandwidth, at the edge of the serving NR carrier. The values assigned to the subcarriers within the LP-WUS's allocated bandwidth can be chosen to cancel interference from other subcarriers within the NR carrier. The aim of LP-WUS design is then to generate a desired/target OOK signal centered around, e.g., IF₂, with sufficient guard band to support cost and integration efficient implementation of baseband BPF enabling good in-band selectivity for the LP-WUR.

FIG. 22 is an illustration of the envelope detection operation 2200 on a signal's frequency spectrum.

In fact, when the receiver is at its minimum sensitivity point, the received LP-WUS RF signal is typically much below the thermal noise floor of the receiver. For a single OOK signal after envelope detection, embodiment techniques may maximize the envelope signal during the ON period of the OOK signal (the OFF period of the signal is simply nulling out the LP-WUS frequency resources). In this case, the algorithm becomes very simple: x is simply a scaled version of the interfering signal, y, frequency shifted to the location of the LP-WUS. In addition, the scaling factor is the information modulated on the IF tone after envelope detection. The freedom in this scaling factor allows in essence any modulation scheme such as OOK, BPSK, QPSK, QAM, etc.

The following analysis compares the minimum sensitivities of the conventional OOK design. and the synergistically generated IF envelope OOK design. It shows that the synergistically generated IF envelope OOK design ideally offers 3 dB better sensitivity than a conventional OOK design.

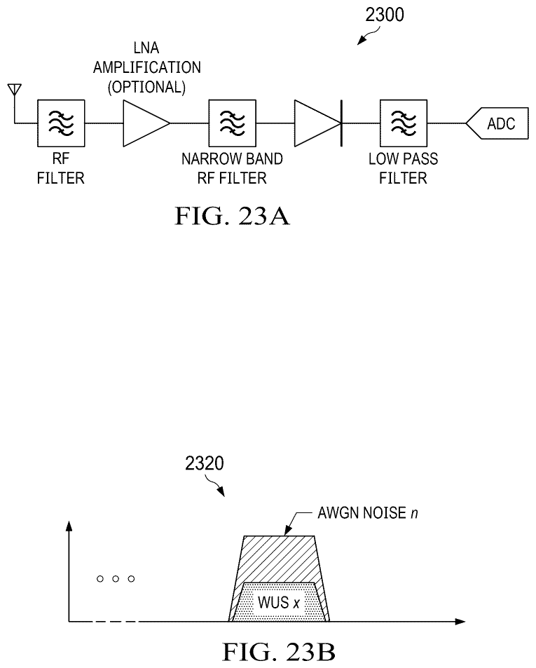

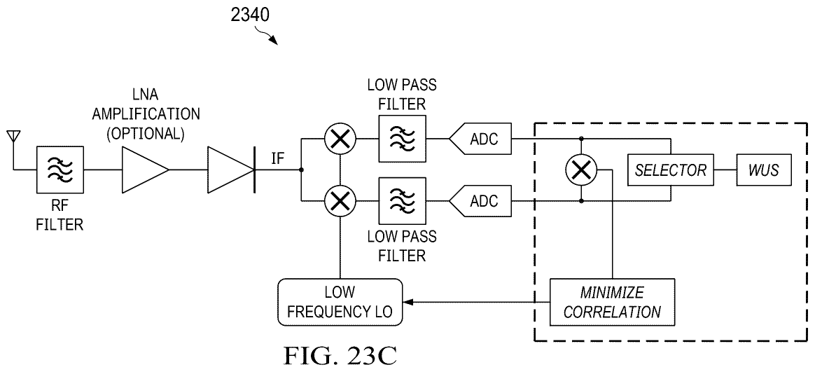

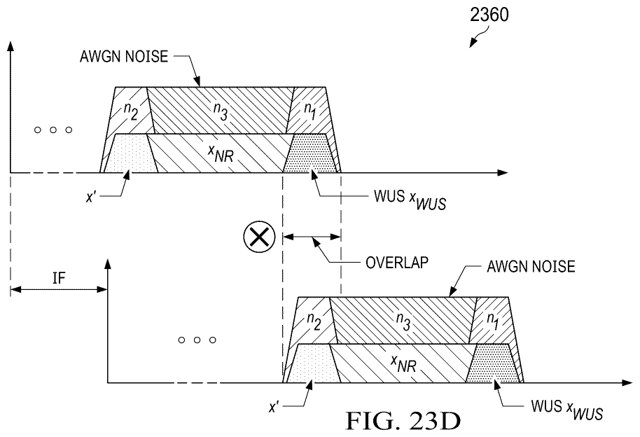

A reference receiver architecture is shown in FIG. 23A for an RF envelope detection receiver for a conventional OOK design. The RF signal from antenna is first filtered by an RF filter (typically wideband), then optionally amplified by a low noise amplifier (LNA). The signal is then filtered by a narrow band RF filter to contain only the OOK signal and the AWGN noise as shown in FIG. 23B. The signal is then passed through an RF envelope detector and low pass filtered. Finally, the signal is sampled by an Analog-to-Digital converter (ADC) to extract the WUS message.

Let x represent the OOK signal, and n represent the AWGN noise, the input to the envelope detector is y=x+n. The output of the envelope detector is:

$${\vert y \vert}^{2} = {\vert x \vert}^{2} + {\vert n \vert}^{2} + 2 * Real [ x * {n}^{*} ]$$

The desired signal is |x|², and its power is E[|x|⁴]. The envelope noise is |n|²+2*Real[x*n*]≈|n|², since at the limit of sensitivity, the RF noise is usually far above the OOK RF signal, E[|n|²]E[|x|²], the cross product between the OOK RF signal and the RF noise is much smaller than the self-product of the RF noise, thus, can be ignored. The RF noise self-product |n|² has a DC component, which can be eliminated through digital signal processing. Embodiment techniques can calculate the remaining interference to the OOK signal as the variance of the envelope signal produced by the noise envelope, namely, |n|²,

$$E [ {( {\vert n \vert}^{2} - E [ {\vert n \vert}^{2} ] )}^{2} ] = E [ {\vert n \vert}^{4} ] - {( E [ {\vert n \vert}^{2} ] )}^{2} = {σ}^{4}$$

where σ² is the variance or power of the AWGN noise.

A reference receiver architecture for synergistically generated IF envelope OOK is shown in FIG. 23C. Other than the absence of a narrowband RF filter compared to FIG. 23A, it is the same as conventional OOK up to the RF envelope detector. After RF envelope detection, the IF envelope signal is demodulated to baseband with a complex demodulator. After low pass filtering, the complex baseband signal is sampled by ADCs into digital domain. In the digital domain, a circuit is implemented to adjust the phase of the local oscillator of the complex demodulator to minimize the correlation between the real and imaginary part of the complex baseband signal. A selector selects the path with the stronger signal to extract the WUS message.

The RF spectrum of the signal at the input to the envelope detector is shown in FIG. 23D. The signal is separated into 3 parts based on their frequencies. On the high frequency side are the WUS signal x_{WUS} and the corresponding RF noise n₁. On the low frequency side are the background traffic signal x′ that will be mixed with WUS signal to produce the desired envelope signal at an IF, and its corresponding RF noise n₁. In the middle are other background traffic signals x_{NR} and its corresponding RF noise n₃. The total input to the envelope detector can be expressed as:

$$y = x + n = {x}_{WUS} * {e}^{- i ( \frac{{ω}_{IF}}{2} ) t} + {x}^{′} * {e}^{i ( \frac{{ω}_{IF}}{2} ) t} + {x}_{NR} + {n}_{1} * {e}^{- i ( \frac{{ω}_{IF}}{2} ) t} + {n}_{2} * {e}^{i ( \frac{{ω}_{IF}}{2} ) t} + {n}_{3}$$

where ω_{IF} is the desired IF envelope frequency. After the envelope detection and complex demodulation, the signal becomes |y|²*e^{iω}^{_{IF}}^{t}. After low pass filtering, all the envelope signals not located at the desired IF frequency are eliminated. The remaining signal is:

$${\vert y \vert}^{2} * {e}^{i {ω}_{IF} t} = {x}_{W U S} * {x}^{′ *} + {x}_{W U S} * {n}_{2}^{*} + {n}_{1} * {x}^{′ *} + {n}_{1} * {n}_{2}^{*}$$

The desired signal is x_{WUS}*x′* and the noise envelope is:

$${x}_{W U S} * {n}_{2}^{*} + {n}_{1} * {x}^{′ *} + {n}_{1} * {n}_{2}^{*} \approx {n}_{1} * {n}_{2}^{*}$$

Since at the limit of sensitivity, RF noise is far above the OOK or background traffic signal, E[|n₁|²], E[|n₂|²]E[|x_{WUS}|²], E[|x′|²], the cross terms between the RF noise and WUS and background traffic signals can be ignored.

x_{WUS}=x′ during the ON period of the OOK modulation, the desired signal is then |x′|², and the noise envelope is n₁*n₂*. Assuming the power spectral density of WUS is kept at the same as the background traffic signal, then the desired IF envelope signal |x′|² is at the same level as |x|² in the conventional OOK case, i.e., the desired signal power is E[|x′|⁴]≈E[|x|⁴]. Notice that the desired signal is real, while the noise envelope is complex. By carefully adjusting the phase of the demodulation as shown in FIG. 23C, the desired signal will only appear in one of the 2 baseband signal branches, embodiment techniques can thus eliminate the imaginary portion of the noise envelope. Therefore the noise envelope becomes Real(n₁×n₂*), where n₁ and n₂ are independent AWGN, and its power is

$$E [ {( Real ( {n}_{1} \times {n}_{2}^{*} ) )}^{2} ] = {σ}^{4} / 2$$

only half that of the conventional OOK case. Therefore, the synergistically generated IF envelope OOK design has 3 dB better SNR and offers 3 dB better sensitivity.

An intuitive way to understand this difference in resulted sensitivity in the envelope detection process is that in the case of conventional OOK, the noise is perfectly correlated with itself, while in the case of synergistically generated IF envelope OOK, the 2 noise signals are independent of each other. It is worth pointing out that if the phase correction is not implemented in the reference radio architecture of FIG. 23(c), the worst case situation is when the two baseband signal branches have about the same strength. In that situation, the 3 dB sensitivity advantage is lost, since the desired signal power is equally divided between the 2 branches.

FIG. 23A shows a reference radio architecture 2300 for conventional OOK. FIG. 23B shows an RF spectrum 2320 of the input signal to the envelope detector for conventional OOK design. FIG. 23C shows a reference radio architecture 2340 for synergistically generated IF envelope OOK. FIG. 23D shows an RF spectrum 2380 of the input signal to the envelope detector for synergistically generated IF envelope OOK design and illustration of the process to produce IF envelope signal.

In addition, in RF envelope detection, perfect spectral selection of the WUS signal is usually not possible. The narrowband RF filter shown in the reference radio architecture of FIG. 23A has high implementation cost. Without such narrowband RF filter, the synergistically generated IF envelope OOK design would offer even more significant sensitivity advantage. The conventional OOK is subject to the interference of the entire AWGN allowed in by the RF filter, while the synergistically generated IF envelope OOK design has in-band selectivity and does not suffer from the interference from the extra AWGN. For example, if the RF bandwidth is 20 MHz, and the WUS allocation is 2.9 MHz, ideally the difference amounts to 8 dB additional sensitivity advantage for the synergistically generated IF envelope design.

### Feasibility for IF/Baseband Envelope Detection

As mentioned earlier, the use of low accuracy and stability LOs for IF/Baseband envelope detection architectures creates uncertainty in the IF/Baseband frequencies occupied by the LP-WUS. The uncertainty requires sufficient guard bands around the LP-WUS to suppress interference from any signal multiplexed on adjacent subcarriers, which may not be a resource efficient solution.

The dual-spectrum allocation scheme may not provide any resource efficiency for IF/Baseband envelope detection receiver architectures since it requires itself enough guard bands, i.e., comparable to LP-WUS allocated bandwidth, around each single allocated spectrum to eliminate interference. It may, however, relax the requirements on the IF BPF characteristics, e.g., for IF envelope detection receiver architectures, which might result in a lower implementation cost and/or better integration capability.

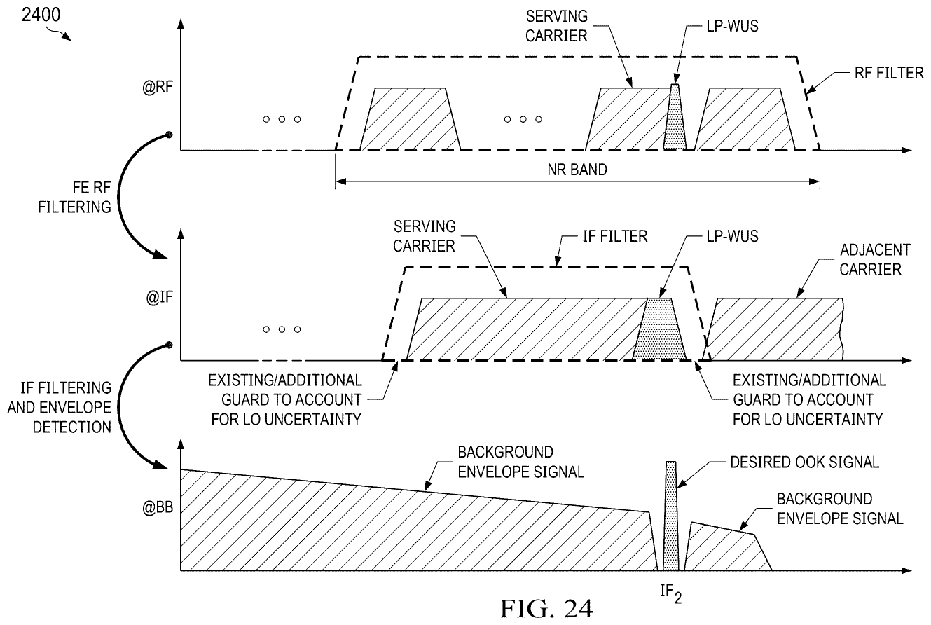

On the other hand, the dynamic LP-WUS design described above can be used to provide a resource efficient solution by generating the target signal at specific/fixed and accurate frequency after envelope detection where the guard bands around NR carriers can be reused, i.e., to minimize the requirements on any additional resources needed to mitigate the LOs uncertainty. Further, the design enables the relaxation of the IF BPF design requirements, i.e., for IF envelope detection receiver architectures. The scheme is illustrated in FIG. 24 for IF envelope detection receiver architectures where the frontend (FE) RF matching network/BPF is used to select a desired NR band, an IF BPF is then used at IF to select the whole desired serving carrier, and an IF envelope detection is used to translate the signal to baseband. The dynamic LP-WUS design then results in a target/desired OOK signal that is located/centered at a specific (and accurate) frequency, IF₂, with sufficient guard band for BB filtering. It is worth noting that the design requirements for the BB filter should be more manageable than IF BPF design requirements due to the expected lower center frequency of IF₂ than at IF.

FIG. 24 is an illustration of feasibility/benefit 2400 of dynamic LP-WUS design for IF envelope detection receiver architectures.

### Feasibility for Higher/Adaptive Data Rates Enablement

Both dual-spectrum allocation scheme and dynamic LP-WUS design scheme can allow the support of data rates higher than the base data rates supported by OFDM-OOK, e.g., 14 kbps at 15 kHz SCS and 28 kbps at 30 kHz SCS. In a first example, a data dependent design can be considered in the dual-spectrum allocation scheme where the target signal after envelope detection is the frequency spectrum of a set/sequence of L bits determined by the data stream and calculated using, e.g., DFT or look-up tables. The LP-WUS at RF on both sides of the carrier spectrum are then designed to result in that target signal after envelope detection. The number of bits L represent the number of bits to be carried/transmitted within any OFDM symbol duration and therefore the supported data rate can then be determined as 14×L kbps at 15 kHz SCS or 28×L kbps at 30 kHz SCS. In this example, the LP-WUS at RF can be determined/calculated on the fly or obtained from a look-up table based on the incoming data stream.

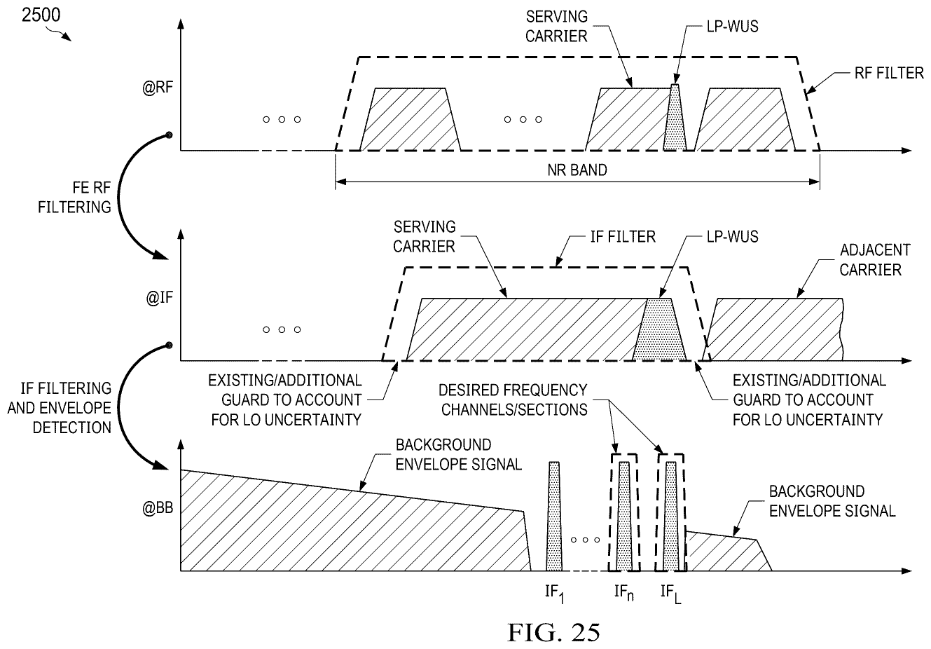

In a second example, the target signal/waveform z of the dynamic LP-WUS design is designed to enable higher data rates than OFDM-OOK base data rates using sequential or parallel bit streams. In sequential bit stream, the target signal/waveform z is determined as the frequency spectrum of a set/sequence of L bits determined by the incoming data stream and calculated using, e.g., DFT or look-up tables. On the other hand, the target signal/waveform z, in the parallel bit stream case which is exemplified in FIG. 25, is split into L sections where each section consists of, e.g., MIL, samples/SCs representing the frequency spectrum, e.g., ON/OFF pulse shape or waveform in frequency domain, of one of L data streams that are obtained by converting the incoming raw LP-WUS data stream into L parallel data streams. The effective data rate in both alternatives can be determined, similar to the first example, as 14×L kbps at 15 kHz SCS or 28×L kbps at 30 kHz SCS.

FIG. 25 is an illustration of parallel bit stream support/generation 2500 using dynamic LP-WUS design for IF envelope detection receiver architectures.

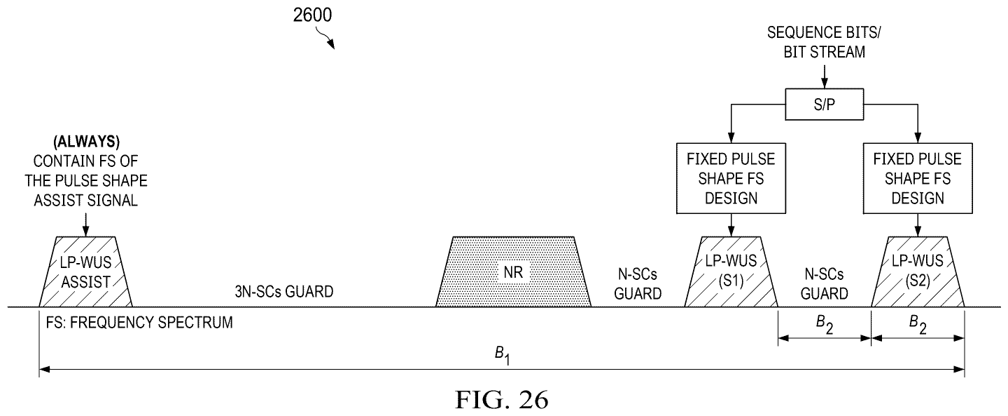

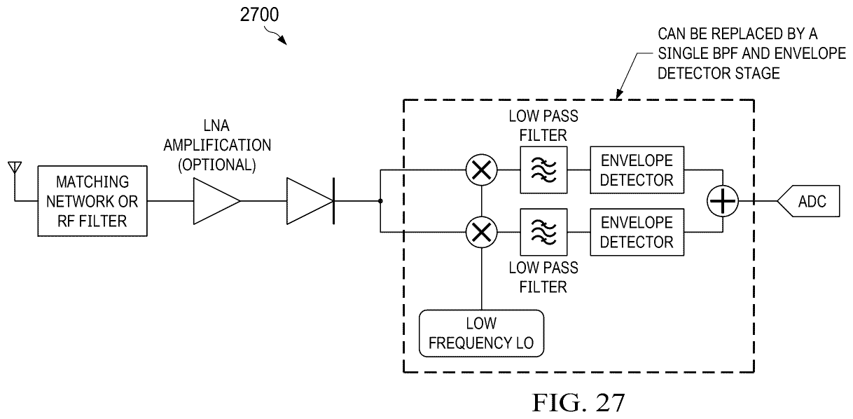

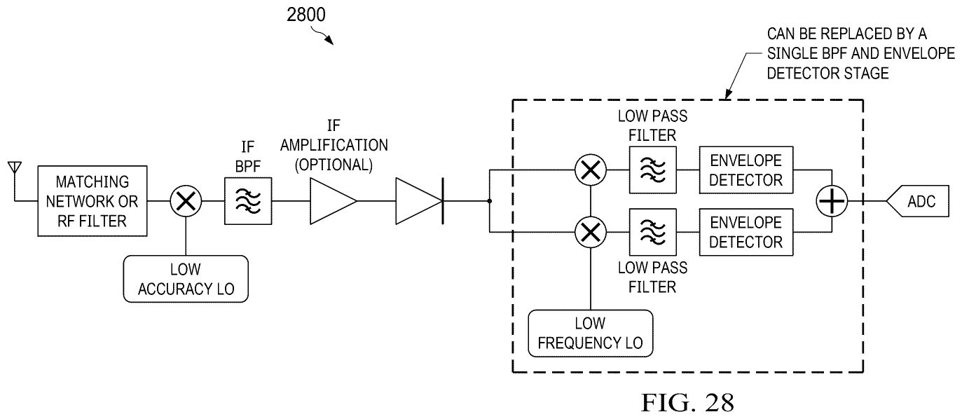

In a third example, parallel channel design can be considered for the dual-spectrum allocation scheme as exemplified in FIG. 26 where the incoming bit stream is split into two parallel stream that are, e.g., OOK modulated. Incoming bits in each stream can be used to trigger a LP-WUS design corresponding to a desired, e.g., ON/OFF pulse shape or waveform in frequency domain, after envelope detection and considering an assisting signal on the other edge of the carrier frequency spectrum. The effective raw data rate corresponding to the example in FIG. 26 and assuming OOK modulation can be determined as 14×2 kbps at 15 kHz SCS or 28×2 kbps at 30 kHz SCS. The scheme exemplified in FIG. 26 can also be extended to L parallel streams. Additionally, each stream may also consider bit grouping or DFT processing as described in the first example. As can be seen in FIG. 26, this scheme may not be spectrally-efficient due to the guard band requirements around each LP-WUS, but can simplify the LP-WUS design.

FIG. 26 is an example frequency response 2600 of a single OFDM symbol under parallel LP-WUS design with dual-spectrum allocation.

In a fourth example, the target signal/waveform z of the dynamic LP-WUS design is designed such that every L consecutive bits in an incoming LP-WUS bit stream are used to trigger one of 2^{L} frequency sections in the target signal/waveform z. Each of the sections consists of M/2^{L} samples/SCs and can carry the ON or OFF pulse shape or waveform in frequency domain. This design can be used to serve LP-WURs supporting 2^{L}-FSK modulation scheme as discussed in above.

### Receiver Architecture and Processing

An example of a simplified low power RF envelope detection receiver architecture that can be used to receiver LP-WUS generated according to any of the approaches discussed above is shown in FIG. 27. The main blocks in that architecture include a front-end RF filter or matching network which are used for out-of-band and/or adjacent channels interference rejection. Note that the embodiment signal design solutions result in relaxed requirements on RF filtering, i.e., very high-Q filtering may not be required, especially for the exemplified RF envelope detection architecture. Further, they have enabled frequency multiplexing of LP-WUS with other NR signals and/or channels. An LNA is optionally considered to improve the LP-WUR sensitivity. A first RF envelope detector is used for RF signal down conversion to base band. A narrowband BPF, centered at a fixed IF frequency determined by LP-WUS design, can then be used for LP-WUS channel/spectrum selection and in-band interference rejection. A self-mixing BB envelope detector, e.g., using an N-PPM type mixer as described above for the dual uncertain-IF architecture, can then be used. Alternatively, the BPF and LP-WUS channel/spectrum down conversion to base band may be realized by a low frequency LO and an N-PPM type mixer followed by an LPF, where the examples shown in FIG. 27 and FIG. 28 are using 2-PPM. In another alternative, a complex mixer with low-frequency LO can be used to center the LP-WUS channel at DC and a narrowband LPF can be used instead of the BPF for LP-WUS channel selection and in-band interference rejection.

FIG. 27 is an exemplary RF envelope detection receiver architecture 2700 supporting dual-spectrum allocation and dynamic LP-WUS design schemes.

Another example of a simplified low power IF envelope detection receiver architecture that can be used to receiver LP-WUS generated according to any of the approaches discussed above is shown in FIG. 28. Similar to the example architecture in FIG. 27, the main blocks of this architecture may include any of a front-end RF filter or matching network, an LNA, a narrowband BPF and/or LPF, a self-mixing/BB envelope detector, and a mixer with low-frequency LO. Additionally, as opposed to the first RF envelope detector, a first IF envelope detector is considered where the input IF signal is filtered with an IF BPF of bandwidth corresponding to the serving NR carrier bandwidth after being converted from RF using a mixer and a low accuracy LO. The mixer may be a complex mixer or a mixer that is combined with an image rejection filter, e.g., front-end matching network or RF filter. Further, an IF amplifier may be optionally considered to improve the LP-WUR sensitivity.

FIG. 28 is an exemplary IF envelope detection receiver architecture 2800 supporting dual-spectrum allocation and dynamic LP-WUS design schemes.

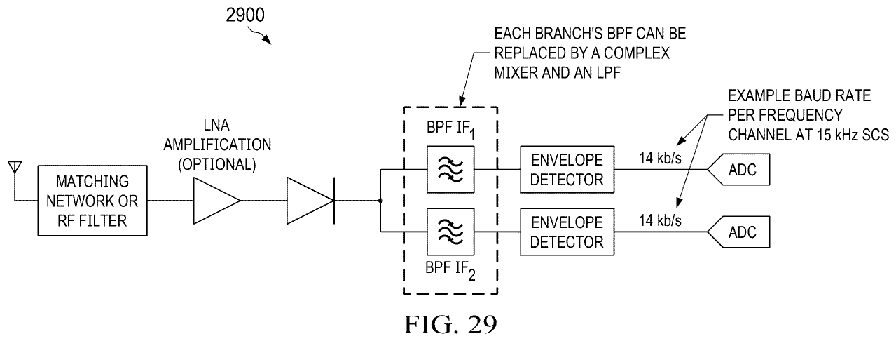

In another example of simplified low power receiver architectures, the exemplified architectures shown in FIG. 27 and FIG. 28 can be reused to support the reception of multiple, e.g., L, parallel streams of, e.g., OOK, modulated bits. The reuse of the RF envelope detection receiver architecture is exemplified in FIG. 29 where two parallel streams each of, e.g., 14 kbps, data rate at, e.g., 15 kHz, SCS are considered.

FIG. 29 is an exemplary RF envelope detection receiver architecture 2900 supporting dual-spectrum allocation and dynamic LP-WUS design schemes with parallel bit streams.

### Procedures to Support Embodiment Signal Design

In this section, signaling and procedures to enable efficient use of the embodiment signal design schemes by proper trade-off between resource utilization efficiency, UE power saving gain, and LP-WUS decoding and/or detection performance. The trade-off may take into account any of channel quality such as path loss and/or fading, intra-cell interference, and inter-cell interference. For example, a UE may configure its LP-WUR to switch from RF envelope detection architecture to IF/BB envelope detection architecture to improve LP-WUS detection/decoding performance at the expense of higher LP-WUR's power consumption. In another example, a UE may configure its LP-WUR to switch from RF envelope detection architecture to IF/BB envelope detection architecture due to presence of interference at edge of carrier to improve LP-WUS detection/decoding performance at the expense of higher LP-WUR's power consumption and/or degraded resource utilization.

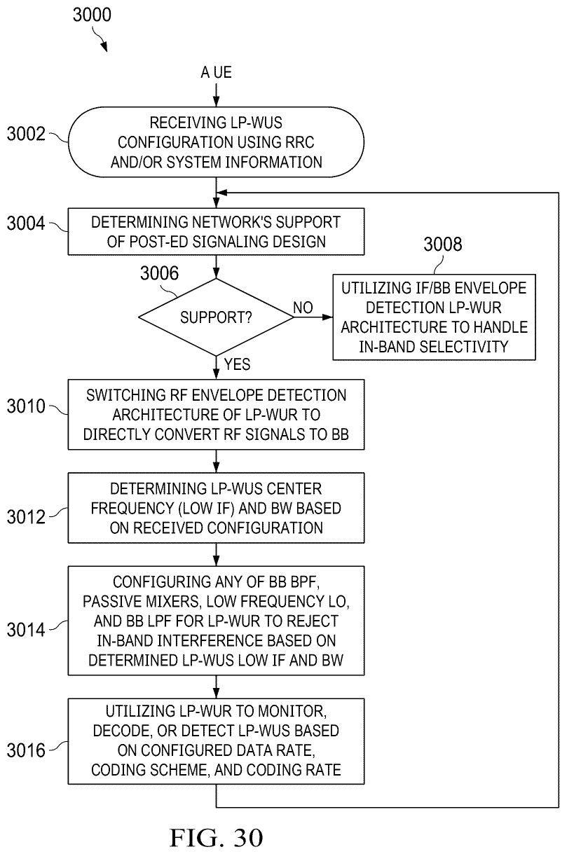

In an embodiment, exemplified in FIG. 30, a UE is equipped with a LP-WUR that can dynamically switch between an RF envelope detection and an IF/BB envelope detection architecture based on network's support. The UE receives, in a first step, LP-WUS configuration using any of RRC and system information signaling. The LP-WUS configuration may include any of
An indication of post-ED signaling design support.
A pre-envelope detection (ED) signal, e.g., LP-WUS and in-band interfering signals, bandwidth.
A post-ED signal, e.g., LP-WUS, center frequency, e.g., IF, and bandwidth.
A LP-WUS transmission data rate, e.g., 14 kbps or 28 kbps, which may be determined based on a signaled SCS and support of DFT precoding, i.e., DFT-OOK.
A LP-WUS coding scheme and coding rate, e.g., Manchester coding with 1/2 coding rate.

The UE, in a second step, determining network's support of post-ED signaling design. In a third step, the UE switches its RF envelope detection LP-WUR architecture based on determined network's support. In an example, the UE switches its RF envelope detection LP-WUR architecture if network's support is determined as part of a received system information configuration. Otherwise, the UE switches its IF/BB envelope detection LP-WUR architecture, i.e., network's support is not determined. In a fourth step, the UE determines LP-WUS's center frequency, e.g., IF, and bandwidth based on received configuration. In a fifth step, the UE configures LP-WUR's baseband circuitry, e.g., filters and/or mixers and/or low frequency LOs, to reject in-band interference and convert LP-WUS into baseband, i.e., LP-WUS centered at DC, using determined center frequency and bandwidth. In a sixth step, the LP-WUR is used to monitor LP-WUS according to configured data rate and coding scheme/rate.

In an alternative to the third step, the UE switches its RF envelope detection LP-WUR architecture based on determined network's support and LP-WUR's capability. In an example, the UE switches its RF envelope detection LP-WUR architecture if network's support is determined and the bandwidth of the RF front-end matching network and/or BPF supports the configured/received pre-ED signal bandwidth. Otherwise, the UE switches its IF/BB envelope detection LP-WUR architecture, i.e., network's support is determined but the bandwidth of the RF front-end matching network and/or BPF does not support the configured/received pre-ED signal bandwidth. Further, the UE switches its IF/BB envelope detection LP-WUR architecture based on absence of network's support of post-ED signaling design.

FIG. 30 is an exemplary flow chart illustrating a process 3000 for UE dynamically switching between RF and IF/BB envelope detection architectures based on network's support. The UE receives an LP-WUS configuration using RRC and/or system information (step 3002). The UE determines network's support of postoED signaling design (step 3004). If the network does not support post-ED signaling, then the process 3000 proceeds from step 3006 to step 3008 where the UE utilizes IF/BB envelope detection LP-WUR architecture to handle in-band selectivity. If the network does support post-ED signaling, then process 3000 proceeds from step 3006 to step 3010 where the UE switches RF envelope detection architecture of LP-WUR to directly convert RF signals to BB. Next, the UE determines LP-WUS center frequency (low IF) and BW based on the received configuration (step 3012). Next, the UE configures any of BB BPF, passive mixers, low frequency LO, and BB LPF for LP-WUR to reject in-band interference based on determined LP-WUS low IF and BW (step 3014). Next, the UE utilizes LP-WUR to monitor, decode, or detect LP-WUS based on configured data rate, coding scheme, and coding rate (step 3016) after which, the process 3000 may proceed back to step 3002.

The indication of post-ED signaling design support may be used to indicate network's support of any of
Extreme LP-WUR power saving gain through proper signal design that alleviates the need for mixer-first architectures, i.e., IF/BB envelope detection architectures.
LP-WURs of RF envelope detection architecture with relaxed front-end requirements on matching networks and/or BPFs.
LP-WURs of IF envelope detection architecture with relaxed requirements on IF BPFs, which may enable relatively high-IF LP-WUR architectures that may consume lower power than low-IF architectures.

The pre-ED signal bandwidth may or may not be equivalent to the serving NR carrier bandwidth and can be conveyed to LP-WURs as any of
An indication/index of one of limited set of bandwidth configurations, e.g., {5 MHz, 10 MHz, 15 MHz, 20 MHz}.
A number of PRBs for a default/configured SCS or a pair of number of PRBs and considered SCS.
An indication of use of serving NR carrier bandwidth.

The post-ED signal bandwidth can be indicated to LP-WUR(s) using any of
An indication/index of one of limited set of bandwidth configurations, e.g., {360 kHz, 720 kHz, 1.44 MHz, 2.88 MHz, . . . }.
A number of PRBs for a default/configured SCS or a pair of number of PRBs and considered SCS.
A number of SCs for a default/configured SCS or a pair of number of SCs and considered SCS.
A list of PRB indices for a default/configured SCS
A list of PRB indices and a considered SCS.

The post-ED signal center frequency can be determined based on post-ED signal bandwidth configuration, e.g., list of PRB indices, or according to a preconfigured formula involving, e.g., pre-ED (B₁) and post-ED (B₂) signal bandwidths, such as IF=B₁−B₂−B_{Offset} where the B_{Offset} parameter may be preconfigured or signaled to LP-WURs. The following one or more information elements may be indicated to LP-WUR(s)
An indication/index of one of limited set of center frequencies (IFs), e.g., {4.28 MHz, 3.56 MHz, 2.12 MHz, . . . }.
An indication/index of one of limited set of center frequencies (IFs) offsets with respect to a default center frequency (IF), e.g., {720 kHz, 1.44 MHz, 2.88 MHz, . . . }.
A pair of PRB and SC indices, i.e., the index of a SC within a PRB indicated by an index.
A number of PRBs for a default/configured SCS with respect to a default center frequency (IF).
A number of SCs for a default/configured SCS with respect to a default center frequency (IF).

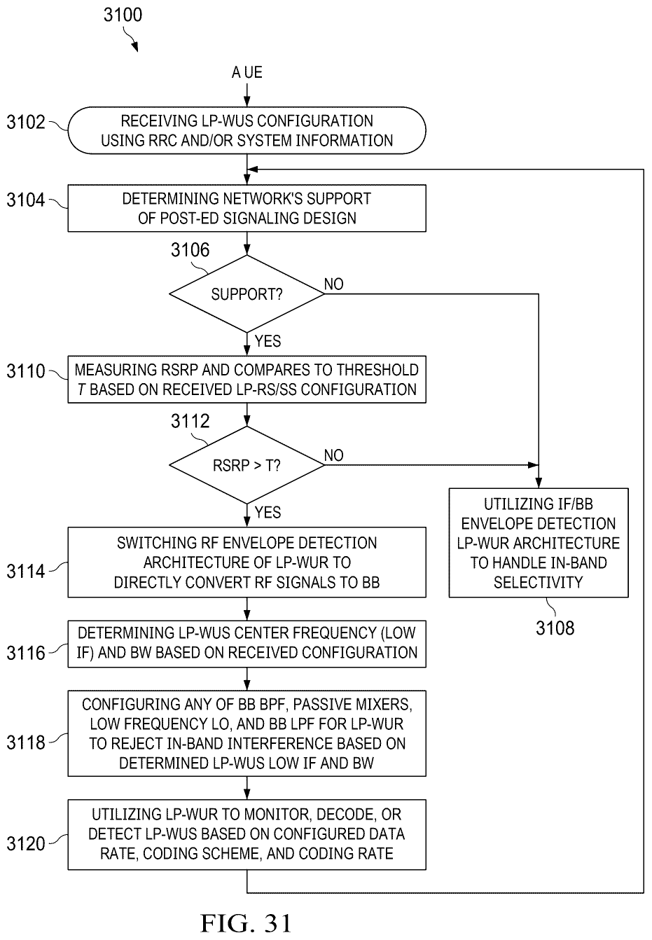

In another embodiment, exemplified in FIG. 31, a UE is equipped with a LP-WUR that can dynamically switch between an RF envelope detection and an IF/BB envelope detection architecture based on network's support and received signal strength. The UE receives, in a first step, LP-WUS configuration using any of RRC and system information signaling. The LP-WUS configuration may include any of
An indication of post-ED signaling design support.
A received signal strength threshold.
A low power reference signal and/or synchronization signal configuration.
A pre-ED signal, e.g., LP-WUS and in-band interfering signals, bandwidth.
A post-ED signal, e.g., LP-WUS, center frequency, e.g., IF, and bandwidth.
A LP-WUS transmission data rate, e.g., 14 kbps or 30 kbps, which may be determined based on a signaled SCS and support of DFT precoding, i.e., DFT-OOK.
A LP-WUS coding scheme and coding rate, e.g., Manchester coding with 1/2 coding rate.

The UE, in a second step, determining network's support of post-ED signaling design. In a third step, the UE utilizes low power reference signal configuration to measure received signal strength. In a fourth step, the UE determines a low power reference signal received signal strength above a configured threshold. In a fifth step, the UE switches its RF envelope detection LP-WUR architecture based on determined network's support and received signal strength. In a sixth step, the UE determines LP-WUS's center frequency, e.g., IF, and bandwidth based on received configuration. In a seventh step, the UE configures LP-WUR's baseband circuitry, e.g., filters and/or mixers and/or low frequency LOs, to reject in-band interference and convert LP-WUS into baseband, i.e., LP-WUS centered at DC, using determined center frequency and bandwidth. In an eighth step, the LP-WUR is used to monitor LP-WUS according to configured data rate and coding scheme/rate.

In an alternative to the fourth step, the UE determines a low power reference signal received signal strength below a configured threshold. Subsequently, in the fifth step, the UE switches its IF/BB envelope detection LP-WUR architecture based on determined network's support and received signal strength.

FIG. 31 is an exemplary flow chart illustrating an embodiment process 3100 for a UE dynamically switching between RF and IF/BB envelope detection architectures based on network's support and RSRP measurements. The UE receives an LP-WUS configuration using RRC and/or system information (step 3102). Next, the UE determines the network's support of post-ED signaling design (step 3104) and if, at step 3106, there is no support, then the process 3100 proceeds o step 3108 where the UE utilizes IF/BB envelope detection LP-WUR architecture to handle in-band selectivity. If, at step 3106, there is support for post-ED signaling design, then the process 3100 proceeds to step 3110 where the UE measures RSRP and compares it to a threshold, T, based on the received LP-RS/SS configuration. Next, at step 3112, if the RSRP is not greater than the threshold, T, the process 3100 proceeds to step 3108 and, if the RSRP is greater than the threshold, the process 3100 proceeds to step 3114 where the UE switches RF envelope detection architecture of the LP-WUR to directly convert RF signals to BB. Next, the UE determines the LP-WUS center frequency (low IFo and BW based on the received configuration (step 3116). Next, the UE configures any of BB BPF, passive mixers, low frequency LO, and BB LPF for LP-WUR to reject in-band interference based on the determined LP-WUS low IF and BW (step 3118). Next, the UE utilizes the LP-WUR to monitor, decode, or detect LP-WUS based on configured data rate, coding scheme, and coding rate (step 3120), after which, the process 3100 may proceed back to step 3102.

The low power reference signal and/or synchronization signal configuration may include any of
An indication of transmission periodicity or aperiodicity
A transmission periodicity which maybe signaled as one of the following
   An index to a value from a set of preconfigured values
   A number of any of OFDM symbols, slots, subframes, and frames
A maximum period/duration between subsequent transmissions in an aperiodic transmission scheme which can be signaled as any of
   An index to a value from a set of preconfigured values
   A number of any of OFDM symbols, slots, subframes, and frames
A signal structure which may include any of one or more known sequence(s) and a payload, where the payload may be characterized by any of
   A fixed or configurable variable size
   A frame check sequence of fixed or configurable length

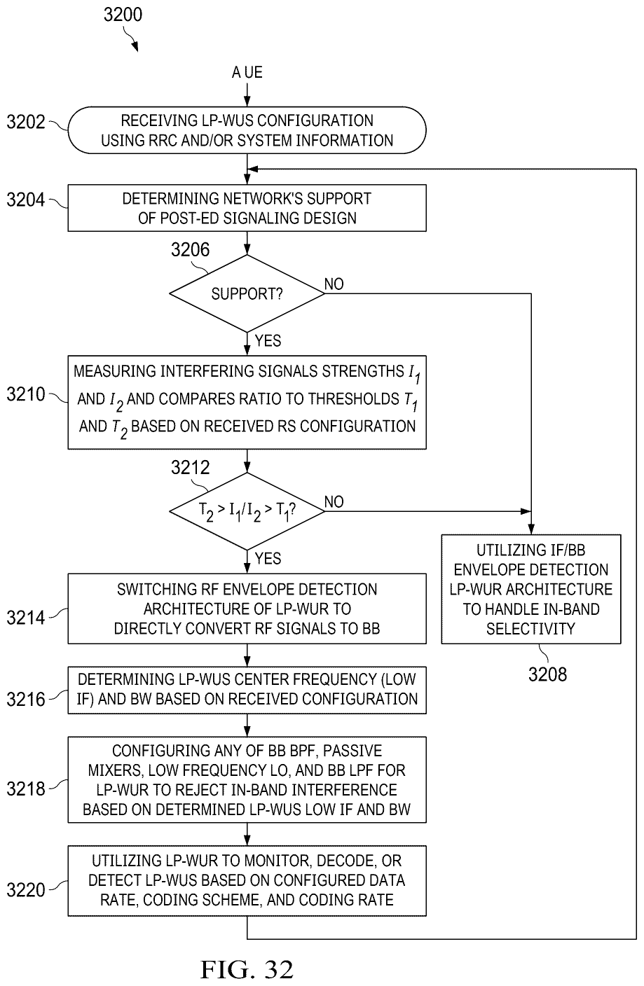

In another embodiment, exemplified in FIG. 32, a UE in, e.g., RRC Connected state, is equipped with a LP-WUR that can dynamically switch between an RF envelope detection and an IF/BB envelope detection architecture based on network's support and experienced interference levels. The UE receives, in a first step, LP-WUS configuration using any of RRC and system information signaling. The LP-WUS configuration may include any of
An indication of post-ED signaling design support.
Configuration of a reference signal that can be used to measure one or more interfering signals which may impact LP-WUS decoding/detection performance.
Criteria on interfering signals measurement to determine applicability of post-ED signaling design, e.g., interfering signal strength on one edge of the carrier is greater than that of the other edge by a configured threshold.
A pre-ED signal, e.g., LP-WUS and in-band interfering signals, bandwidth.
A post-ED signal, e.g., LP-WUS, center frequency, e.g., IF, and bandwidth.
A LP-WUS transmission data rate, e.g., 14 kbps or 30 kbps, which maybe determined based on a signaled SCS and support of DFT precoding, i.e., DFT-OOK.
A LP-WUS coding scheme and coding rate, e.g., Manchester coding with 1/2 coding rate.

The UE, in a second step, determining network's support of post-ED signaling design. In a third step, the UE utilizes reference signal configuration to measure interfering signals. In a fourth step, the UE determines satisfaction of post-ED signaling criterion, e.g., ratio of interfering signals strengths on both edges of the carrier lies between a first and second configured thresholds. In a fifth step, the UE requests enablement of post-ED signaling and switches its RF envelope detection LP-WUR architecture. In a sixth step, the UE determines LP-WUS's center frequency, e.g., IF, and bandwidth based on received configuration. In a seventh step, the UE configures LP-WUR's baseband circuitry, e.g., filters and/or mixers and/or low frequency LOs, to reject in-band interference and convert LP-WUS into baseband, i.e., LP-WUS centered at DC, using determined center frequency and bandwidth. In an eighth step, the LP-WUR is used to monitor LP-WUS according to configured data rate and coding scheme/rate.

In an alternative to the fourth step, the UE determines that the post-ED signaling criterion is not satisfied, e.g., ratio of interfering signals strengths on both edges of the carrier is below the first configured threshold or above the second configured threshold. Subsequently, in the fifth step, the UE switches its IF/BB envelope detection LP-WUR architecture without post-ED signaling. Alternatively, in the fifth step, the UE requests enablement of post-ED signaling with a target center frequency (IF) below currently configured one, e.g., request to increase the size of the guard bands at one or both of the edges of the carrier, and switches its RF envelope detection LP-WUR architecture.

FIG. 32 is an exemplary flow chart illustrating an embodiment process 3200 for a UE dynamically switching between RF and IF/BB envelope detection architectures based on network's support and interfering signals measurements. The UE receives the LP-WUS configuration using RRC and/or system information (step 3202). Next, the UE determines the network's support of post-ED signaling design (step 3204). Next, at step 3206, if the network does not support post-ED signaling design, the process 3200 proceeds to step 3208 where the UE utilizes IF/BB envelope detection LP-WUR architecture to handle in-band selectivity. If, at step 3206, the network does support post-ED signaling design, the process 3200 proceeds to step 3210 where the UE measures interfering signals strengths I₁ and I₂ and compares the ratio to thresholds T₁ and T₂ based on the received RS configuration. Next, at step 3212, if T₂>1/I₂>T₁ is not true, then the process 3200 proceeds back to step 3208. If, at step 3212, T₂>I₁/I₂>T₁ is true, then the process 3200 proceeds to step 3214 where the UE switches RF envelope detection architecture of LP-WUR to directly convert RF signals to BB. Next, the UE determines the LP-WUS center frequency (low IF) and BW based on the received configuration (step 3216). Next, the UE configures any of the BB BPF, passive mixers, low frequency LO, and BB LPF for LP-WUR to reject in-band interference based on the determined LP-WUS low IF and BW (step 3218). Next, the UE utilizes the LP-WUR to monitor, decode, or detect LP-WUS based on configured data rate, coding scheme, and coding rate (step 3220), after which, the process 3200 may proceed back to step 3202.

In another embodiment, a base station enables dual-spectrum allocation for LP-WUS transmission to a LP-WUR. The base station, in a first step, configures LP-WUS transmission parameters. The LP-WUS configuration may include any of
A post-ED signaling using dual-spectrum allocation design.
A set of frequency resources allocated for LP-WUS transmission.
A LP-WUS target transmission data rate, e.g., 14 kbps or 28 kbps.
A LP-WUS modulation/coding scheme and coding rate, e.g., Manchester coding with 1/2 coding rate.
A LP-WUS target base band bandwidth and center frequency, i.e., IF after envelope detection.

The base station, in a second step, determining a first and a second subsets of frequency resources based on target baseband center frequency. In a third step, the base station determines signal resources and guard band resources in the first and the second subsets of frequency resources based on target base band bandwidth and center frequency. In a fourth step, the base station allocates a first set of symbols at a first power scaling factor to the signal resources of the first subset of frequency resources. In a fifth step, the base station allocates a second set of symbols at a second power scaling factor to the signal resources of the second subset of frequency resources based on any of the LP-WUS information bits, the data rate, the modulation scheme, the coding scheme, and the coding rate. In a sixth step, the base station applies the frequency domain generated signal to an IFFT module and completes an OFDM transmission.

The set of frequency resources allocated for LP-WUS transmission are non-contiguous and may occupy two subsets of contiguous frequency resources on, e.g., two sides of a channel or a carrier. The base station may further signal one or more of the following information elements to the UE equipped with a LP-WUR
An indication of post-ED signaling using, e.g., dual-spectrum allocation design.
A post-ED signal, e.g., LP-WUS, center frequency, e.g., IF, and bandwidth.
A LP-WUS data rate, e.g., 14 kbps or 28 kbps.
A LP-WUS coding scheme and coding rate, e.g., Manchester coding with 1/2 coding rate.

In another embodiment, a base station enables synergistically generated IF-envelope for LP-WUS transmission to a LP-WUR. The base station, in a first step, configures LP-WUS transmission parameters. The LP-WUS configuration may include any of
A post-ED signaling using synergistically generated IF-envelope design.
A first set of frequency resources allocated for LP-WUS transmission.
A LP-WUS target transmission data rate, e.g., 14 kbps or 28 kbps.
A LP-WUS modulation/coding scheme and coding rate, e.g., Manchester coding with 1/2 coding rate.
A LP-WUS target base band bandwidth and center frequency, i.e., IF after envelope detection.

The base station, in a second step, determining a first set of symbols allocated to a second set of frequency resources based on the configured target baseband bandwidth and center frequency. In a third step, the base station determines signal resources and guard band resources in the first set of frequency resources based on the configured target baseband bandwidth and center frequency, and the determined second set of frequency resources. In a fourth step, the base station determines a second set of symbols and a power scaling factor based on any of the following:
the LP-WUS information bits,
the determined first set of symbols,
the configured LP-WUS target baseband bandwidth,
the configured LP-WUS baseband center frequency,
the configured LP-WUS modulation/coding scheme and coding rate.

In a fifth step, the base station allocates the second set of symbols at the power scaling factor to the signal resources of the first set of frequency resources. In a sixth step, the base station applies the frequency domain generated signal to an IFFT module and completes an OFDM transmission.

The first set of symbols are determined based on modulation and coding of signals that maybe transmitted over, e.g., a Physical downlink control channel (PDCCH) or a Physical downlink shared channel (PDSCH). The guard band resources may not be required if the size of the second set of resources is sufficient for the target LP-WUS baseband bandwidth at the target baseband center frequency.

### Architectures

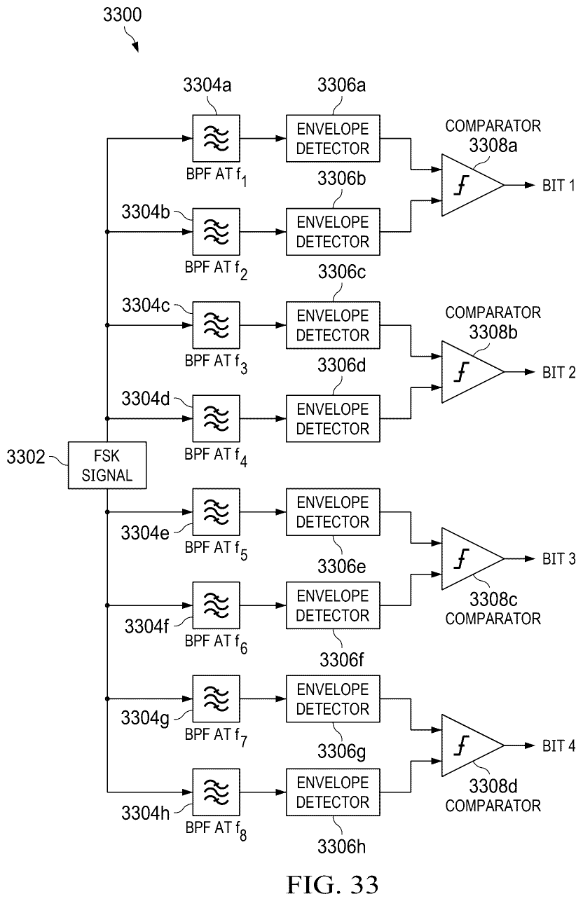

FIG. 33 shows an example 2-bit FSK receiver architecture 3300 utilizing parallel OOK receivers in accordance with an embodiment. Architecture 3300 includes an FSK signal 3302 which is input to each of BPF 3304. The outputs of BPFs 3304 are input into corresponding envelope detectors 3306. The output of each pair of envelope detectors 3306 is input into a corresponding comparator 3308, each of which outputs a corresponding bit 1, bit 2, bit 3, or bit 4. In order to increase the data rate received by an FSK receiver, a higher modulation order may be considered, i.e., M-FSK (M>4). In the example 2-bit FSK receiver, i.e., 4-FSK, shown in FIG. 33, 4 different frequency resources are used to indicate 2 bits as exemplified in the table of FIG. 33. At the FSK receiver, 4 bandpass filters centered at the 4 frequencies on 4 different branches are used prior to envelope detection. The output of the envelope detectors is then fed into a decision-making unit which decides on one of the 4 different 2-bit combinations based on the relative strength/amplitude of the envelope detectors output.

In RAN1 #110 bis-e, three types of receiver architectures were agreed to be considered for the LP-WUR as suitable for OOK modulation. These include architectures with RF envelope detection, heterodyne architecture with IF envelope detection, and homodyne/zero-IF architecture with baseband envelope detection. These architectures can also be applicable for other modulation schemes such as FSK where an RF FSK receiver can be realized by two parallel OOK receivers with RF BPFs centered at, e.g., two different frequencies as shown in FIG. 15, and an IF FSK receiver can be realized by a mixer first architecture with, e.g., parallel OOK receivers using IF BPFs centered at, e.g., two different frequencies as shown in FIG. 18.

The RF envelope detection architecture achieves low-power consumption by avoiding the utilization of Local Oscillators (LOs) and Phase-Locked Loops (PLLs). The removal of LOs creates another challenge for RF envelope detection architectures where suppression of interference from legacy NR signals/channels or other LP-WUSs on adjacent subcarriers may require very high-Q matching networks and/or RF BPFs. Implementations of high-Q matching networks and/or RF BPFs can be costly and/or bulky, e.g., require off-chip components. The IF/Baseband envelope detection architectures achieve low-power consumption by relaxing the accuracy and stability requirements of the LO. On the other hand, the use of low accuracy and stability LOs for IF/Baseband envelope detection architectures creates uncertainty in the IF/Baseband frequencies occupied by the LP-WUS. The uncertainty requires sufficient guard bands around the LP-WUS, i.e., FSK modulated signal, to suppress interference from any signal multiplexed on adjacent subcarriers.

The aforementioned challenges are particularly concerning for high order modulation FSK receiver architectures, i.e., more than two symbols (two frequencies) are required as shown in FIG. 33, which may be utilized to support higher data rates than the 2-FSK architectures shown in FIG. 15 and FIG. 18. The data rate of the example 1-bit FSK receiver architectures shown in FIG. 15 and FIG. 18 is around 28 kbps assuming operation at FR1 with subcarrier spacing (SCS) of 30 kHz.

Therefore, a solution is desired to aid low-power, e.g., envelope detection based, FSK receiver architectures support high data rates, i.e., higher order modulation M-FSK where M>2, without significant impact on any of the receiver implementation cost, the receiver implementation size, and network resource overhead. The following sections will discuss these solutions.

It is noted that the example 4-FSK receiver architecture shown in FIG. 33 uses 4 frequency resources to receive 2 bits. Likewise, an 8-FSK receiver based on the architecture shown in FIG. 33 uses 8 frequency resources to receive 3 bits, i.e., in general 2^{N} frequency resources can be used to transmit N-bits using such an M-FSK, where M=2^{N}, receiver architecture. Such an exponential increase in the required frequency resources is undesirable for an M-FSK receiver architecture.

There are two potential multiplexed structures for multi-bit FSK, i.e., M-FSK for M>2, receivers that can achieve that goal which are presented and described below.
2N frequency multiplexed structure
N+2 frequency multiplexed structure

Each of these architectures will require 2N and N+2 non-contiguous frequency resources, respectively, to receive N bits using an M-FSK, M=2^{N}, modulation. Procedures that support the operation of such receiver architectures are described herein.

The modulation scheme hereafter is called frequency shift keying (FSK) but other terminology may also be considered such as low power coded modulation, resource efficient OOK modulation, frequency domain coded OOK modulation, differential OOK modulation, etc.

### Embodiment Receiver Architectures

### 2N Frequency Multiplexed Structure

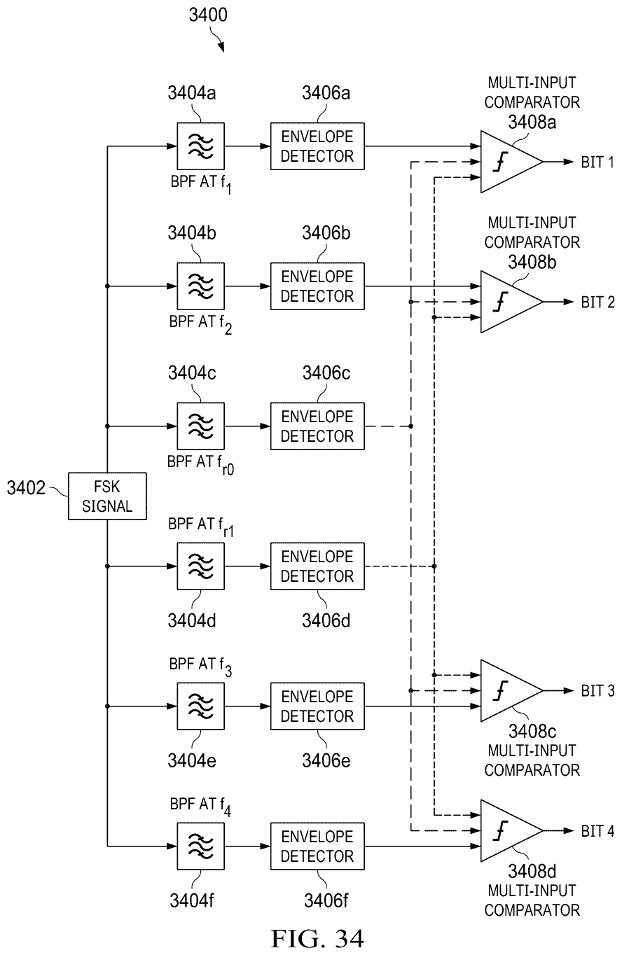

In this structure, multiple 1-bit FSK receiver architectures, such as shown in FIG. 15 and FIG. 18, are used in parallel to increase the supported data rate. An example 4-bit FSK, i.e., 16-FSK, receiver structure 3400 is shown in FIG. 34 where only 8 RF/IF BPFs maybe used instead of the 16 that would be required for the M-FSK architecture exemplified in FIG. 33.

Receiver structure 3400 includes an FSK signal 3402 that is input into each of BPFs 3404. The output of each of BPFs 3404 is input into a corresponding envelope detector 3406. The output of envelope detectors 3406a, 3406b, 3406e, 3406f is input into a corresponding multi-input comparator 3408a, 3408b, 3408c, 3408d. the output of each of envelope detectors 3406c, 3406d is input into each of the multi-input comparators 3408a, 3408b, 3408c, 3408d. the output of each multi-input comparator 3408 corresponds to a respective bit 1, bit 2, bit 3, and bit 4.

At the transmitter side, the first bit (Bit 1) is associated with frequency resources f₁ and f₂ where a transmission at frequency f₁ may be used to represents a “0” and a transmission at frequency f₂ may be used represents a “1”, or vice versa. Similarly, the second (Bit 2), third (Bit 3), and fourth (Bit 4) bits may be associated with the frequency pairs (f₃, f₄), (f₅, f₆), and (f₇, f₈), respectively.

At the receiver side, as shown in FIG. 34, the received signal is split and passed through a set of RF/IF BPFs where each pair is associated with a single bit, e.g., BPFs at ft and f₂ are used to detect the first bit (Bit 1). The outputs of BPFs are then passed through envelope detectors and each output pair, e.g., outputs at frequencies f₁ and f₂, is fed into a comparator to decide on the detection result, i.e., a bit “0” or bit “1” is detected. Similar process is used for the detection of each of the other bits, i.e., Bit 2, Bit 3, and Bit 4.

It is worth noting that the structure in FIG. 34 can be thought of as a single 4-bit FSK receiver, two 2-bit FSK receivers, or four 1-bit FSK receivers receiving one/two/four different FSK signals that are multiplexed in the frequency domain, i.e., one/two/four LP-WUS channels are enabled in parallel.

The architecture in FIG. 34, therefore, requires in general only 2N frequency resources to realize N bits per OFDM symbol which alleviate the guard bands issue, particularly associated with the low power mixer first IF based envelope detector architectures with low accuracy oscillators as discussed earlier, compared to architectures such as shown in FIG. 33 requiring 2^{N} frequency resources. This is still helpful for RF envelope detector based FSK receiver architectures, but they might have less advantages due to their use of costly and/or bulky bandpass filters.

Another FSK receiver structure that can further reduce the number of required frequency resources to transmit N bits using FSK based modulation is discussed next.

### N+2 Frequency Multiplexed Structure

In the FSK receiver structure described in above, each bit is associated with a pair of frequency resources where a frequency resource is used as reference when the other resource is used for transmission, therefore each frequency resource alternates between acting as a reference and as a carrier to transmit a bit of information. In another structure, exemplified as a 4-bit FSK receiver in FIG. 34, two frequency resources are selected to represent a fixed reference for the other set of frequency resources, each used as a carrier to transmit a bit of information. The embodiment structure can then support the transmission of N bits using only N+2 frequency resources as opposed to 2N required by the structure exemplified in 4.

At the transmitter side, the first bit (Bit 1) is associated with frequency resources f₁ where a transmission at frequency f₁ maybe used to represents a “1” and absence of transmission at frequency ft may be used represents a “0”, or vice versa. To assist the envelope detection based FSK receiver in estimation of whether there was a transmission at frequency f₁ or not, a “null” transmission is considered at frequency fᵣ₀ while a “consistent” transmission is considered at frequency fᵣ₁. Similarly, the second (Bit 2), third (Bit 3), and fourth (Bit 4) bits may be associated with the frequencies f₂, f₃ and f₄, respectively, while considering “null” and “consistent” reference signals at frequencies fᵣ₀ and fᵣ₁, respectively.

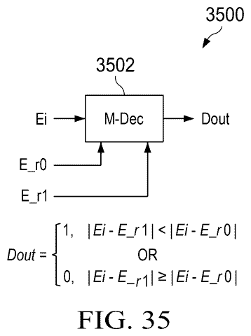

At the receiver side, as shown in FIG. 34, the received signal is split and passed through a set of RF/IF BPFs where one dedicated, e.g., BPF at f₁, and two shared, e.g., BPFs at fᵣ₀ and fᵣ₁, are used to detect a single bit, e.g., the first bit (Bit 1). The outputs of BPFs are then passed through envelope detectors and each output tuple, e.g., outputs at frequencies f₁ and fᵣ₀ and fᵣ₁, is fed into a multi-input (multi-threshold) comparator, e.g., multi-threshold detection (M-Dec) unit, to decide on the detection result, i.e., a bit “0” or bit “1” is detected. A similar process is used for the detection of each of the other bits, i.e., Bit 2, Bit 3, and Bit 4. The algorithm, e.g., decision criteria, that the M-Dec 3502, e.g., multi threshold comparator, unit may use is shown in FIG. 35 where Eᵢ represent the signal at the output of the envelope detector after BPF at frequency f₁.

The embodiment signal design and corresponding 4-bit FSK receiver structure in FIG. 34 then requires only 6 frequency resources which, compared to 8 frequency resources, represents 38% saving in number of BPFs and frequency resources over the structure in FIG. 33. Further, this represents ˜63% saving in number of BPFs and frequency resources over the original M-FSK receiver structure in FIG. 33.

It is also worth noting that similar to the structure in FIG. 33, the structure in FIG. 34 can be thought of as a single 4-bit FSK receiver, two 2-bit FSK receivers, or four 1-bit FSK receivers receiving one/two/four different FSK signals that are multiplexed in the frequency domain, i.e., one/two/four LP-WUS channels are enabled in parallel. Further, the structure in FIG. 34 can be thought of in general as parallel OOK receivers with frequency domain coding where, e.g., two, fixed reference frequencies are used for proper estimation of noise and/or interference.

### N+1 Frequency Multiplexed Structure

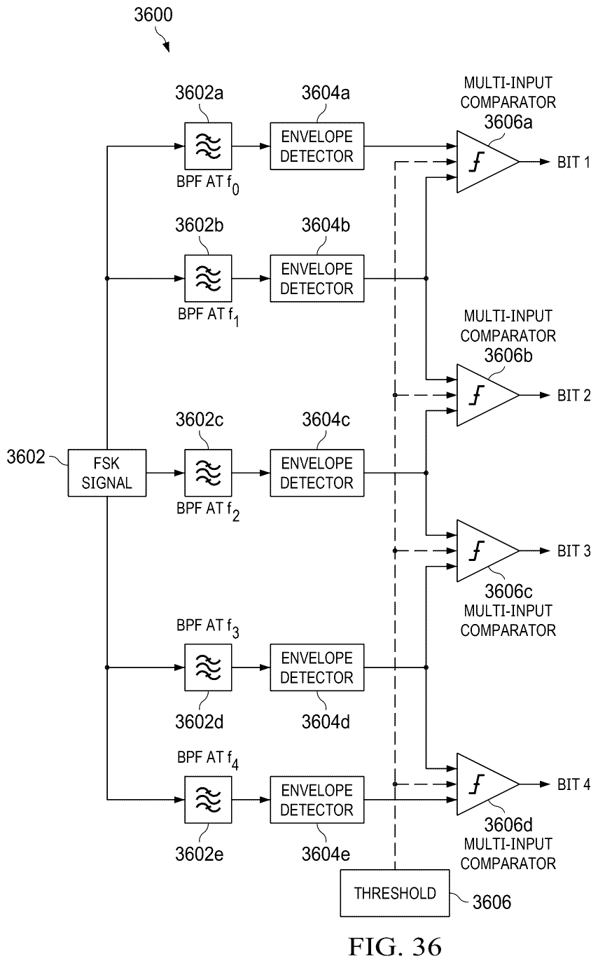

In this section, another receiver structure 3600, exemplified in FIG. 36 as a parallel 4-bit receiver, that can receive N bits using only N+1 frequency resources based on a differential modulation/coding scheme is disclosed. The receiver structure 3600 includes an FSK signal 3602 that is input into each of BPF 3602 and the output of each BPF 3602 is input into a corresponding envelope detector 3604. The output of envelope detector 3604a is input into multi-input comparator 3606a. The output of envelope detector 3604b is input into both multi-input comparator 3606a and multi-input comparator 3606b. The output of envelope detector 3604c is input into both multi-input comparator 3606b and multi-input comparator 3606c. The output of envelope detector 3604d is input into both multi-input comparator 3606c and multi-input comparator 3606d. The output of envelope detector 3604e is input into multi-input comparator 3606d. A threshold 3606 is input into each of the multi-input comparators 3606. The output of each of the multi-input comparators 3606 is respective bit 1, bit 2, bit 3, and bit 4.

At the transmitter side, a reference signal is transmitted on the first resource f₀ whereas the i^{th} bit, Bᵢ, maybe encoded to generate the Sᵢ bit using the (i−1)^{th} encoded bit according to the following formula:

$${S}_{i} = {S}_{i - 1} ⊕ {B}_{i} , i ∈ \{ 1 , 2 , … , N \}$$

Where ⊕ represents the binary XOR operation. The reference signal on the first resource f₀ maybe assigned a “null” or a “consistent” transmission to assist the parallel envelope detection based differential receiver. The i^{th} coded bit, Sᵢ, is associated with the i^{th} frequency resource f₁ where an active transmission at frequency resource f₁ may be used to represents a “1”, i.e., Sᵢ=1, and absence of active transmission at frequency resource f₁ maybe used represents a “0”, i.e., Sᵢ=0, or vice versa.

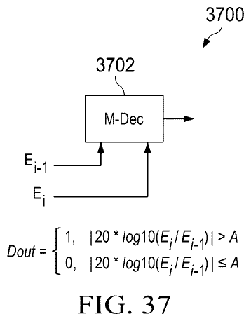

At the receiver side, as exemplified in FIG. 36, the received signal is split and passed through a set of RF/IF BPFs and envelope detectors. Subsequently, the envelope detector output/level at frequency resource i, Eᵢ, is compared to the envelope detector output/level at frequency resource (i−1), Eᵢ₋₁, to determine/detect the information bit Bᵢ using the decision block/unit, M-Dec. The algorithm, e.g., decision criteria, that the M-Dec unit 3702 may use is shown in FIG. 37 where Eᵢ and Eᵢ₋₁ represent the output of the envelope at frequency resources fᵢ₋₁ and fᵢ, respectively.

In another variation, the receiver architecture, exemplified in FIG. 34, may be modified to receive N+1 bits instead of the N bits described above. In this variation, the transmitter modulates the two reference resources fᵣ₀ and fᵣ₁ to convey one additional information bit, e.g., Bit 0, using the 1-bit FSK modulation whereas the remaining N bits are modulated differently, i.e., the i^{th} bit is still associated with frequency resources f₁ where a transmission at frequency f₁ may be used to represents a “1” and absence of transmission at frequency f₁ may be used represents a “0”, or vice versa. At the receiver side, a single threshold comparator may be used to decode the additional bit, e.g., Bit 0, associated with the two reference resources. The detection criteria presented in FIG. 36 is still used for the initial decoding of Bit i∈{1, 2, . . . , N}, but the final value of Bit 1 is determined based on the decoded Bit 0, i.e., depending on the value of Bit 0, the initial decoding of Bit i∈{1, 2, . . . , N} may be inverted.

### Procedures Supporting Dynamic FSK Modulated Signal Design

In this section, the system, signaling and procedures are outlined to use the embodiment resource efficient FSK/OOK modulation and demodulation schemes and corresponding low power wake-up receiver structures. The system can further enable resource-efficient frequency domain multiplexing of LP-WUSs directed to multiple low power FSK/OOK receivers.

### Procedures at the Transmitter

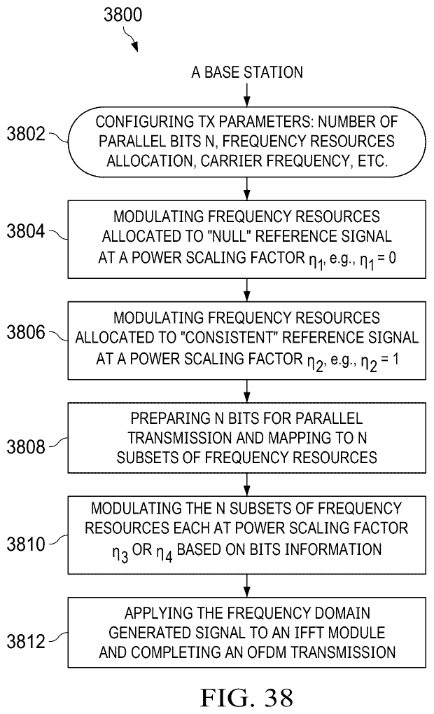

In an embodiment process 3800, exemplified in the flow chart of FIG. 38, a base station processes a LP-WUS for a single LP-WUR using two fixed frequency resources as reference. In a first step, the base station uses higher layer configuration to determine any of a set of frequencies allocated for LP-WUS(s) transmission, number of bits multiplexed in an OFDM symbol, number of LP-WUSs multiplexed in the frequency domain, a first subset of frequency resources allocated for “null” reference signal, a second subset of frequency resources allocated for “consistent” reference signal (step 3802). In a second step, the base station assigns a first set of symbols for the “null” reference signal at a first power scaling factor η₁ (step 3804). In a third step, the base station assigns a second set of symbols for the “consistent” reference signal at a second power scaling factor η₂ (step 3806). The base station then prepares N bits for parallel transmission and mapping to N subsets of frequency resources (step 3808). In a fourth step, the base station determines one or more subsets of frequencies to be allocated to one or more bits associated with one or more LP-WUS transmission. In a fifth step, the base station assigns a third or a fourth set of symbols to each of the one or more determined subsets of frequencies based on the value/information of each of the one or more bits, e.g., “0” bit or “1” bit and in a sixth step, the base station applies a third η₃ or a fourth η₄ power scaling factor to each of the one or more determined subsets of frequencies based on the value/information of each of the one or more bits, e.g., “0” bit or “1” bit (step 3810). In a seventh step, the base station applies the frequency domain generated signal to an IFFT module and completes an OFDM transmission (step 3812).

In an alternative to the first step, the base station determines the first and the second subsets of frequency resources based on any of the configured, e.g., by higher layers, set of frequencies allocated for LP-WUS(s) transmission, number of bits multiplexed in an OFDM symbol, and number of LP-WUSs multiplexed in the frequency domain.

Different technical realizations may be considered for the first and the second power scaling factors in the second and the third steps. In one technical realization, the first power scaling factor is selected to be smaller than the second power scaling factor. In a second technical realization, the first power scaling factor is selected to be zero.

Different technical realizations may be considered for the first and the second sets of symbols in the second and the third steps. In one technical realization, the first and the second sets of symbols are chosen to be the same. For example, both the first and the second set of symbols are selected based on configured one or more known sequence(s), e.g., Zadoff-Chu sequence(s). In another technical realization, the first and the second sets of symbols are chosen to be different. For example, the first set of symbols are selected as an all zero symbols whereas the second set of symbols are selected based on configured one or more known sequence(s), e.g., Zadoff-Chu sequence(s). It is worth noting that the size of the set of symbols depends on the size of allocated frequency resources which may correspond to one or more allocated subcarriers, i.e., frequency resources. Further, one of the one or more known sequences may be selected for each transmitted bit per OFDM symbol based on any of randomizing number initialized by, e.g., higher layers, OFDM symbol index, slot number, and subframe number.

In the fifth and the sixth steps, the third set of symbols and the third power scaling factor are associated with “0” bit and the fourth set of symbols and the fourth power scaling factor are associated with “1” bit.

Different technical realizations may be considered for the third and the fourth sets of symbols. In one technical realization, the third and fourth sets of symbols are chosen to be the same as the first and the second sets of symbols, respectively. In another technical realization, the third and the fourth sets of symbols are chosen to be the same, but different than the first and the second sets of symbols, where other configured one or more known sequence(s) may be considered to determine the sets of symbols. In another technical realization, the third set of symbols is chosen to be the same as the first set of symbols and the fourth set of symbols is selected differently than the second set of symbols based on different one or more known sequence(s).

Different technical realizations may be considered for the third and the fourth power scaling factors. In one technical realization, the third and fourth power scaling factors are chosen to be the same as the first and the second power scaling factors, respectively. In another technical realization, the first and third power scaling factors are chosen to be the same whereas the second and fourth power scaling factors are chosen to be different.

Different technical realizations may be considered for the determination of the set of frequency resources and their distribution, as subsets, to reference signals and N parallel bits. The set of frequency resources may be determined as a set of N_{T} contiguous, e.g., subcarriers (SCc) or physical resource blocks (PRBs). The size of frequency resources, e.g., subsets, assigned to either reference signals or bits is configured as a number of, e.g., Nₛ SCs or PRBs, which may include a number N_{G} of resources as guard band. The indices of the first resource in the subsets associated/assigned to the two reference signals may then be configured or determined as, e.g.,

$${I}_{1} = \frac{{N}_{T} ( N + 2 )}{2 {N}_{s}} - {N}_{s} + 1 and {I}_{2} = \frac{{N}_{T} ( N + 2 )}{2 {N}_{s}} + 1 .$$

Additionally, the index of the first resource in the subset associated/assigned to the i^{th} bit may be determined as (i−1)Nₛ+1, if the value is <I₁, and as (i+1)Nₛ+1, otherwise. In an alternative, the size of frequency resources, e.g., subsets, assigned to either reference signals or bits maybe configured as a number of, e.g., Nₛ SCs or PRBs, which may not include a number N_{G} of resources as guard band. The indices of the first resource in the subsets associated/assigned to the two reference signals may then be configured or determined as, e.g.,

$${I}_{1} = \frac{{N}_{T} ( N + 2 )}{2 ( {N}_{s} + {N}_{G} )} - ( {N}_{s} + {N}_{G} ) + 1 and {I}_{2} = \frac{{N}_{T} ( N + 2 )}{2 ( {N}_{s} + {N}_{G} )} + 1 .$$

Additionally, the index of the first resource in the subset associated/assigned to the i^{th} bit may be determined as (i−1)(Nₛ+N_{G})+1, if the value is <I₁, and as (i+1)(Nₛ+N_{G})+1, otherwise. In another technical realization, a total bandwidth B_{T} may replace the total number of resources N_{T}, a signal bandwidth Bₛ may replace the number of subset resources Nₛ, and a guard bandwidth BG may replace the number of guard band resources N_{G}.

In another embodiment, a base station processes an LP-WUS for a single LP-WUR using two randomized frequency resources as reference. In a first step, the base station uses higher layer configuration to determine any of a set of frequencies allocated for LP-WUS(s) transmission, number of bits multiplexed in an OFDM symbol, number of LP-WUSs multiplexed in the frequency domain, a first resource randomization pattern for “null” reference signal, a second resource randomization pattern for “consistent” reference signal. In a second step, the base station assigns a first set of symbols for the “null” reference signal at a first power scaling factor η₁. In a third step, the base station assigns a second set of symbols for the “consistent” reference signal at a second power scaling factor η₂. In a fourth step, the base station determines a first and a second subset of frequency resources allocated for “null” reference signal “consistent” reference signal, respectively, based on the configured first and second resource randomization patterns, respectively. In a fifth step, the base station determines remaining one or more subsets of frequencies to be allocated to one or more bits associated with one or more LP-WUS transmission. In a sixth step, the base station assigns a third or a fourth set of symbols to each of the remaining one or more determined subsets of frequencies based on the value/information of each of the one or more bits, e.g., “0” bit or “1” bit. In a seventh step, the base station applies a third η₃ or a fourth η₄ power scaling factor to each of the one or more determined subsets of frequencies based on the value/information of each of the one or more bits, e.g., “0” bit or “1” bit. In an eighth step, the base station applies the frequency domain generated signal to an IFFT module and completes an OFDM transmission.

The first and second resource randomization pattern may consist of one or more of the following:
A set of indices indicating the sequence of frequency resource subsets within the set of frequency resources allocated for LP-WUS(s) transmission.
One or more initializing seed/parameter to a sequence of known structure, e.g., PN or Zadoff-Chu.
An offset or a cyclic shift to a sequence from an initial sequence obtained using configured initializing seed/parameter.
A sequence length based on the length of the LP-WUS transmission and number of frequency resource subsets within the pattern.

Note that a single resource randomization pattern may be considered when the “null” and “consistent” reference signals alternate between two known/configured subsets of frequency resources. Further, the one or more initializing seed/parameter and/or the offset or cyclic shift may be determined based on any of an OFDM index, a slot number, and a subframe number where the LP-WUS transmission starts. The pattern may be reset at the LP-WUR through the detection of a known preamble indicating the beginning of a LP-WUS reception.

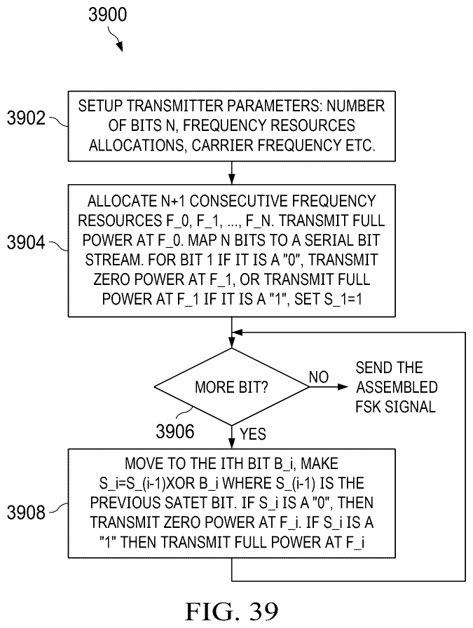

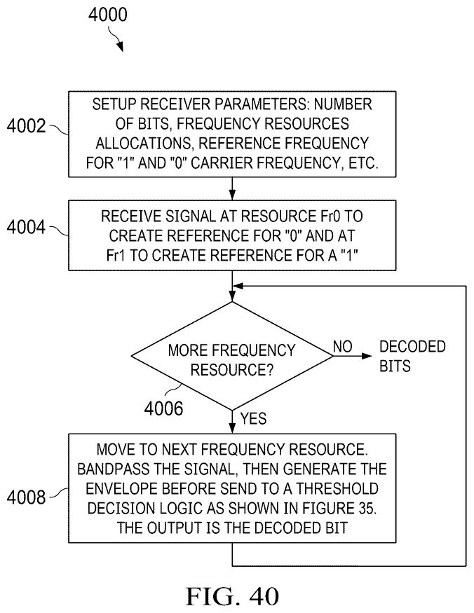

In an alternative embodiment process 3900, exemplified in the flow chart of FIG. 39, a base station processes a LP-WUS for a single LP-WUR using differential modulation. In a first step, the base station uses higher layer configuration to determine any of a set of frequencies allocated for a LP-WUS transmission, number of bits in an OFDM symbol, a first resource for “consistent” reference signal, e.g., resource 0 (step 3902). In a second step, the base station assigns a first set of symbols for the “consistent” reference signal at a first power scaling factor η₁. In a third step, the base station determines one or more subsets of frequencies based on the configured any of set of frequencies, the number of bits in an OFDM symbol, and the first resource. In a fourth step, the base station assigns a second or a third set of symbols to the i^{th} subset of frequencies based on the value/information of the i^{th} bit, e.g., “0” bit or “1” bit, and the assigned set of symbols on the (i−1)^{th} subset of frequencies. In a fifth step, the base station applies a second η₂ or η₃ a third power scaling factor to each of the one or more determined subsets of frequencies based on the assigned one or more set of symbols, e.g., the second set or the third set. In a sixth step, the base station applies the frequency domain generated signal to an IFFT module and completes an OFDM transmission (step 3904). If there are more bits to process (step 3906), the process 3900 proceeds to step 3908 where the base station moves to the ith bit B_i, make S_i=S_(i−1)XOR B_i where S_(i−1) is the previous state bit. If S_i is a “0”, then transmit zero power at F_i and if S_i is a “1” then transmit full power at F_i. If, at step 3906 there are no more bits, then send the assembled FSK symbol.

### Procedures at the Low Power Receiver

In an embodiment process 4000, exemplified in the flow chart of FIG. 40, a UE processes a LP-WUS using two fixed frequency resources as reference. In a first step, the LP-WUR is configured by the UE, e.g., higher layers, using any of the following information/configuration received as part of any of RRC signaling and system information (step 4002):
a set of frequencies allocated for LP-WUS(s) transmission,
number of bits multiplexed in an OFDM symbol,
number of LP-WUSs multiplexed in the frequency domain,
a first subset of frequency resources allocated for “null” reference signal,
a second subset of frequency resources allocated for “consistent” reference signal.

In a second step, the UE determines one or more subsets of frequencies to be allocated to one or more bits associated with its LP-WUS transmission. In a third step, the LP-WUR utilizes the signal received over the first subset of frequency resources to determine a first threshold T₁, e.g., estimate noise level. In a fourth step, the LP-WUR utilizes the signal received over the second subset of frequency resources to determine a second threshold T₂, e.g., estimate of interference power and channel fading level step 4004). In a fifth step, the LP-WUR utilizes the determined first and second thresholds, T₁ and T₂, and the one or more signal levels Eᵢ to detect one or more bits (step 4008).

The determined one or more subsets of frequencies, in the second step, along with the first and the second subsets of frequency resources may only constitute a portion of the set of frequencies allocated for LP-WUS(s) transmissions, i.e., other portions may be allocated to other UEs. Further, the first and the second subsets of frequency resources may be shared with the other UEs. In one technical realization, the one or more subsets of frequencies are determined based on a UE's configured ID or a UE's configured group ID.

In one technical realization of the fifth step, a bit “0” is detected/determined if the absolute difference between the determined signal level Eᵢ and the determined first threshold is smaller than the absolute difference between the determined signal level Eᵢ and the determined second threshold. Otherwise, a bit “1” is detected/determined.

In another embodiment, a UE processes a LP-WUS using two randomized frequency resources as reference. In a first step, the LP-WUR is configured by the UE, e.g., higher layers, using any of the following information/configuration received as part of any of RRC signaling and system information:
a set of frequencies allocated for LP-WUS(s) transmission,
number of bits multiplexed in an OFDM symbol,
number of LP-WUSs multiplexed in the frequency domain,
a first resource randomization pattern for “null” reference signal,
a second resource randomization pattern for “consistent” reference signal.

In a second step, the UE determines a first and a second subset of frequency resources allocated for “null” reference signal “consistent” reference signal, respectively, based on the configured first and second resource randomization patterns, respectively. In a third step, the UE determines remaining one or more subsets of frequencies to be allocated to one or more bits associated with its LP-WUS transmission. In a fourth step, the LP-WUR utilizes the signal received over the first subset of frequency resources to determine a first threshold T₁, e.g., estimate noise level. In a fifth step, the LP-WUR utilizes the signal received over the second subset of frequency resources to determine a second threshold T₂, e.g., estimate of interference power and channel fading level. In a sixth step, the LP-WUR utilizes the one or more signals received over the determined remaining one or more subsets of frequencies to determine one or more signal levels Eᵢ. In a seventh step, the LP-WUR utilizes the determined first and second thresholds, T₁ and T₂, and the one or more signal levels Eᵢ to detect one or more bits.

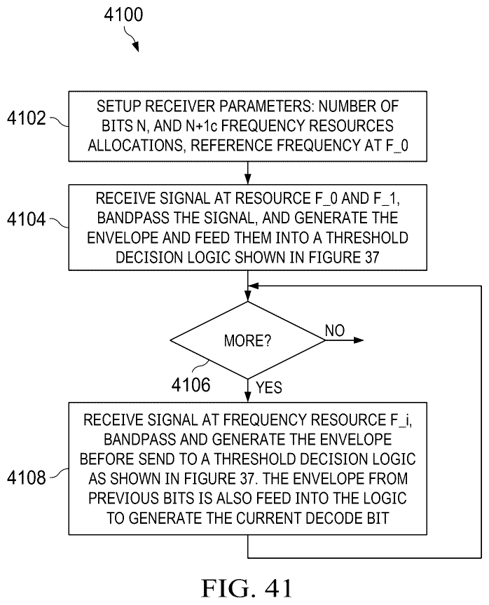

In another embodiment, exemplified in FIG. 41, a UE processes a LP-WUS using one frequency resource as reference. In a first step, the LP-WUR is configured by the UE, e.g., higher layers, using any of the following information/configuration received as part of any of RRC signaling and system information:
a set of frequencies allocated for LP-WUS(s) transmission,
number of bits multiplexed in an OFDM symbol, e.g., N,
a first resource for “consistent” reference signal,

In a second step, the UE determines one or more subsets of frequencies to be allocated to one or more bits associated with its LP-WUS transmission based the configured set of resources, the first resource, and the number of multiplexed bits. In a third step, the LP-WUR utilizes the signal received over the first resource to determine signal level E₀, e.g., an input for a first decision logic M-Dec, shown in FIG. 37. In a fourth step, the LP-WUR utilizes one or more signals received over the determined one or more subsets of frequencies to determine one or more signal levels Eᵢ(step 4104). In a fifth step, the LP-WUR utilizes the determined Eᵢ₋₁ and Eᵢ signal levels as additional inputs to ith M-Dec block (in FIG. 37) to detect the ith bit based on a preconfigured threshold (step 4108). In a sixth step, repeat the fifth step until all bits are detected, e.g., i=N.

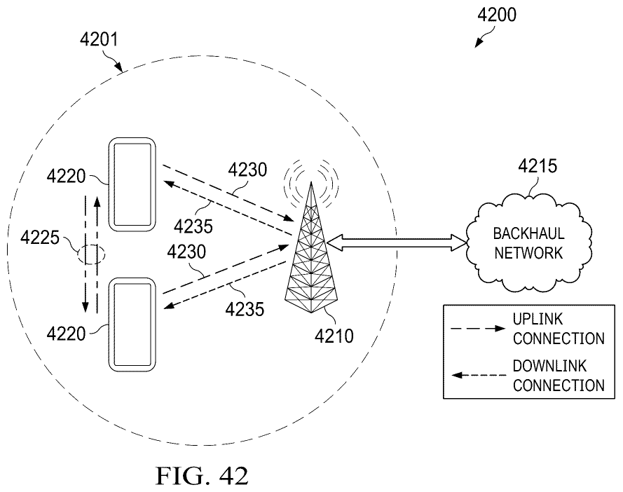

FIG. 42 illustrates an example communications system 4200. Communications system 4200 includes an access node 4210 serving user equipment (UEs) with coverage 4201, such as UEs 4220. In a first operating mode, communications to and from a UE passes through access node 4210 with a coverage area 4201. The access node 4210 is connected to a backhaul network 4215 for connecting to the internet, operations and management, and so forth. In a second operating mode, communications to and from a UE do not pass through access node 4210, however, access node 4210 typically allocates resources used by the UE to communicate when specific conditions are met. Communications between a pair of UEs 4220 can use a sidelink connection (shown as two separate one-way connections 4225). In FIG. 42, the sideline communication is occurring between two UEs operating inside of coverage area 4201. However, sidelink communications, in general, can occur when UEs 4220 are both outside coverage area 4201, both inside coverage area 4201, or one inside and the other outside coverage area 4201. Communication between a UE and access node pair occur over uni-directional communication links, where the communication links between the UE and the access node are referred to as uplinks 4230, and the communication links between the access node and UE is referred to as downlinks 4235.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

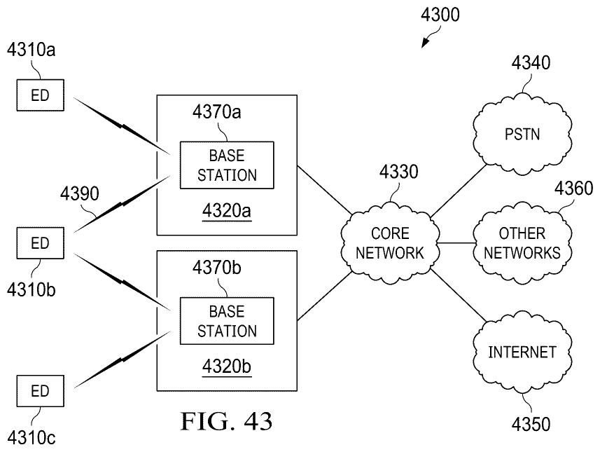

FIG. 43 illustrates an example communication system 4300. In general, the system 4300 enables multiple wireless or wired users to transmit and receive data and other content. The system 4300 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 4300 includes electronic devices (ED) 4310a-4310c, radio access networks (RANs) 4320a-4320b, a core network 4330, a public switched telephone network (PSTN) 4340, the Internet 4350, and other networks 4360. While certain numbers of these components or elements are shown in FIG. 43, any number of these components or elements may be included in the system 4300.

The EDs 4310a-4310c are configured to operate or communicate in the system 4300. For example, the EDs 4310a-4310c are configured to transmit or receive via wireless or wired communication channels. Each ED 4310a-4310c represents any suitable end user device and may include such devices (or may be referred to) as a user equipment or device (UE), wireless transmit/receive unit (WTRU), mobile station, fixed or mobile subscriber unit, cellular telephone, personal digital assistant (PDA), smartphone, laptop, computer, touchpad, wireless sensor, or consumer electronics device. The WTRU might include a transmitter, a receiver, or a combination thereof.

The RANs 4320a-4320b here include base stations 4370a-4370b, respectively. Each base station 4370a-4370b is configured to wirelessly interface with one or more of the EDs 4310a-4310c to enable access to the core network 4330, the PSTN 4340, the Internet 4350, or the other networks 4360. For example, the base stations 4370a-4370b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 4310a-4310c are configured to interface and communicate with the Internet 4350 and may access the core network 4330, the PSTN 4340, or the other networks 4360.

In the embodiment shown in FIG. 43, the base station 4370a forms part of the RAN 4320a, which may include other base stations, elements, or devices. Also, the base station 4370b forms part of the RAN 4320b, which may include other base stations, elements, or devices. Each base station 4370a-4370b operates to transmit or receive wireless signals within a particular geographic region or area, sometimes referred to as a “cell.” In some embodiments, multiple-input multiple-output (MIMO) technology may be employed having multiple transceivers for each cell.

The base stations 4370a-4370b communicate with one or more of the EDs 4310a-4310c over one or more air interfaces 4390 using wireless communication links. The air interfaces 4390 may utilize any suitable radio access technology.

It is contemplated that the system 4300 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 4320a-4320b are in communication with the core network 4330 to provide the EDs 4310a-4310c with voice, data, application, Voice over Internet Protocol (VoIP), or other services. Understandably, the RANs 4320a-4320b or the core network 4330 may be in direct or indirect communication with one or more other RANs (not shown). The core network 4330 may also serve as a gateway access for other networks (such as the PSTN 4340, the Internet 4350, and the other networks 4360). In addition, some or all of the EDs 4310a-4310c may include functionality for communicating with different wireless networks over different wireless links using different wireless technologies or protocols. Instead of wireless communication (or in addition thereto), the EDs may communicate via wired communication channels to a service provider or switch (not shown), and to the Internet 4350.

Although FIG. 43 illustrates one example of a communication system, various changes may be made to FIG. 43. For example, the communication system 4300 could include any number of EDs, base stations, networks, or other components in any suitable configuration.

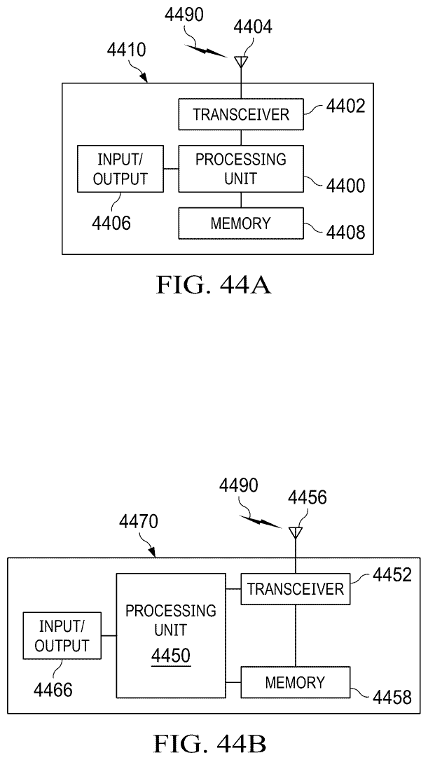

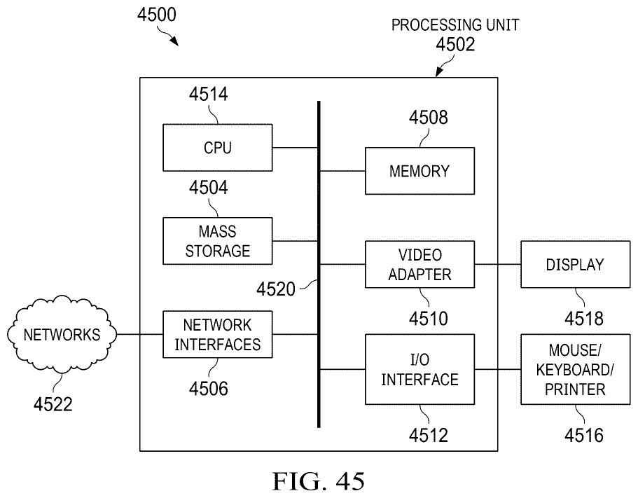

FIGS. 44A and 44B illustrate example devices that may implement the methods and teachings according to this disclosure. In particular, FIG. 44A illustrates an example ED 4410, and FIG. 44B illustrates an example base station 4470. These components could be used in the system 4300 or in any other suitable system.

As shown in FIG. 44A, the ED 4410 includes at least one processing unit 4400. The processing unit 4400 implements various processing operations of the ED 4410. For example, the processing unit 4400 could perform signal coding, data processing, power control, input/output processing, or any other functionality enabling the ED 4410 to operate in the system 4300. The processing unit 4400 also supports the methods and teachings described in more detail above. Each processing unit 4400 includes any suitable processing or computing device configured to perform one or more operations. Each processing unit 4400 could, for example, include a microprocessor, microcontroller, digital signal processor, field programmable gate array, or application specific integrated circuit.

The ED 4410 also includes at least one transceiver 4402. The transceiver 4402 is configured to modulate data or other content for transmission by at least one antenna or NIC (Network Interface Controller) 4404. The transceiver 4402 is also configured to demodulate data or other content received by the at least one antenna 4404. Each transceiver 4402 includes any suitable structure for generating signals for wireless or wired transmission or processing signals received wirelessly or by wire. Each antenna 4404 includes any suitable structure for transmitting or receiving wireless or wired signals. One or multiple transceivers 4402 could be used in the ED 4410, and one or multiple antennas 4404 could be used in the ED 4410. Although shown as a single functional unit, a transceiver 4402 could also be implemented using at least one transmitter and at least one separate receiver.

The ED 4410 further includes one or more input/output devices 4406 or interfaces (such as a wired interface to the Internet 4350). The input/output devices 4406 facilitate interaction with a user or other devices (network communications) in the network. Each input/output device 4406 includes any suitable structure for providing information to or receiving information from a user, such as a speaker, microphone, keypad, keyboard, display, or touch screen, including network interface communications.

In addition, the ED 4410 includes at least one memory 4408. The memory 4408 stores instructions and data used, generated, or collected by the ED 4410. For example, the memory 4408 could store software or firmware instructions executed by the processing unit(s) 4400 and data used to reduce or eliminate interference in incoming signals. Each memory 4408 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 44B, the base station 4470 includes at least one processing unit 4450, at least one transceiver 4452, which includes functionality for a transmitter and a receiver, one or more antennas 4456, at least one memory 4458, and one or more input/output devices or interfaces 4466. A scheduler, which would be understood by one skilled in the art, is coupled to the processing unit 4450. The scheduler could be included within or operated separately from the base station 4470. The processing unit 4450 implements various processing operations of the base station 4470, such as signal coding, data processing, power control, input/output processing, or any other functionality. The processing unit 4450 can also support the methods and teachings described in more detail above. Each processing unit 4450 includes any suitable processing or computing device configured to perform one or more operations. Each processing unit 4450 could, for example, include a microprocessor, microcontroller, digital signal processor, field programmable gate array, or application specific integrated circuit.

Each transceiver 4452 includes any suitable structure for generating signals for wireless or wired transmission to one or more EDs or other devices. Each transceiver 4452 further includes any suitable structure for processing signals received wirelessly or by wire from one or more EDs or other devices. Although shown combined as a transceiver 4452, a transmitter and a receiver could be separate components. Each antenna 4456 includes any suitable structure for transmitting or receiving wireless or wired signals. While a common antenna 4456 is shown here as being coupled to the transceiver 4452, one or more antennas 4456 could be coupled to the transceiver(s) 4452, allowing separate antennas 4456 to be coupled to the transmitter and the receiver if equipped as separate components. Each memory 4458 includes any suitable volatile or non-volatile storage and retrieval device(s). Each input/output device 4466 facilitates interaction with a user or other devices (network communications) in the network. Each input/output device 4466 includes any suitable structure for providing information to or receiving/providing information from a user, including network interface communications.

FIG. 45 is a block diagram of a computing system 4500 that maybe used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 4500 includes a processing unit 4502. The processing unit includes a central processing unit (CPU) 4514, memory 4508, and may further include a mass storage device 4504, a video adapter 4510, and an I/O interface 4512 connected to a bus 4520.

The bus 4520 may be one or more of any type of several bus architectures including a memory bus or memory controller, a peripheral bus, or a video bus. The CPU 4514 may comprise any type of electronic data processor. The memory 4508 may comprise any type of non-transitory system memory such as static random access memory (SRAM), dynamic random access memory (DRAM), synchronous DRAM (SDRAM), read-only memory (ROM), or a combination thereof. In an embodiment, the memory 4508 may include ROM for use at boot-up, and DRAM for program and data storage for use while executing programs.

The mass storage 4504 may comprise any type of non-transitory storage device configured to store data, programs, and other information and to make the data, programs, and other information accessible via the bus 4520. The mass storage 4504 may comprise, for example, one or more of a solid state drive, hard disk drive, a magnetic disk drive, or an optical disk drive.

The video adapter 4510 and the I/O interface 4512 provide interfaces to couple external input and output devices to the processing unit 4502. As illustrated, examples of input and output devices include a display 4518 coupled to the video adapter 4510 and a mouse, keyboard, or printer 4516 coupled to the I/O interface 4512. Other devices may be coupled to the processing unit 4502, and additional or fewer interface cards may be utilized. For example, a serial interface such as Universal Serial Bus (USB) (not shown) may be used to provide an interface for an external device.

The processing unit 4502 also includes one or more network interfaces 4506, which may comprise wired links, such as an Ethernet cable, or wireless links to access nodes or different networks. The network interfaces 4506 allow the processing unit 4502 to communicate with remote units via the networks. For example, the network interfaces 4506 may provide wireless communication via one or more transmitters/transmit antennas and one or more receivers/receive antennas. In an embodiment, the processing unit 4502 is coupled to a local-area network 4522 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules maybe an integrated circuit, such as field programmable gate arrays (FPGAs) or application-specific integrated circuits (ASICs).

Although the description has been described in detail, it should be understood that various changes, substitutions and alterations may be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method implemented in a wireless transmit/receive unit (WTRU) for wireless communications, the method comprising:
receiving a low-power wake-up signal (LP-WUS) configuration indicating a first type of signaling, a second type of signaling, and a reference signal configuration, wherein the WTRU includes a first power state and a second power state;
determining a received signal strength based on the reference signal configuration;
based on a first condition on the received signal strength, operating a receiver in the first power state and monitoring signals according to the first type of signaling; and
based on a second condition on the received signal strength, operating the receiver in the second power state and monitoring the signals according to the second type of signaling.

2. The method of claim 1, wherein the reference signal configuration further indicates a configured signal strength intensity.

3. The method of claim 2, wherein the first condition being the received signal strength above the configured signal strength intensity.

4. The method of claim 3, wherein the second condition being the received signal strength below the configured signal strength intensity.

5. The method of claim 1, wherein the LP-WUS configuration further indicates a post envelope detection (ED) center frequency and a post ED bandwidth.

6. The method of claim 5, wherein the first power state is lower than the second power state.

7. The method of claim 6, wherein the monitoring the signals according to the first type of signaling is based on the post ED center frequency and the post ED bandwidth.

8. The method of claim 1, wherein the LP-WUS configuration further indicates one or more pre-ED center frequencies and one or more pre-ED bandwidths.

9. The method of claim 8, wherein the monitoring the signals according to the second type of signaling is based on the one or more pre-ED center frequencies and the one or more pre-ED bandwidths.

10. The method of claim 1, wherein a radio frequency (RF) ED LP-WUR is utilized in the first power state.

11. The method of claim 1, wherein an intermediate frequency (IF)/baseband (BB) ED LP-WUR is utilized in the second power state.

12. The method of claim 1, wherein the LP-WUS configuration indicating at least one of support for a post-ED signaling design, a pre-ED signal, a post-ED signal, a LP-WUS transmission data rate, or a LP-WUS coding scheme and coding rate.

13. The method of claim 1, wherein the first condition is post-ED signaling design being supported.

14. The method of claim 1, wherein the second condition is post-ED signaling design not being supported.

15. A method comprising:
transmitting, by a base station, a low-power wake-up signal (LP-WUS) that produces a signal at at least a specific intermediate/center frequency (IF) after/post envelope detection (ED) for wake-up signal (WUS) message demodulation and detection in a receiver.

16. The method of claim 15, wherein the LP-WUS transmitted by the base station includes at least two sets of contiguous frequency resources separated by the specific IF.

17. The method of claim 16, wherein the LP-WUS transmitted by the base station includes at least one contiguous frequency resource, and background traffic signals at frequencies are separated from the contiguous frequency resource by the specific IF.

18. A method implemented in a wireless device, the method comprising:
receiving a low-power wake-up signal (LP-WUS) configuration from a network side device, the LP-WUS configuration indicating a set of frequency resources allocated for LP-WUS transmission;
determining one or more subsets of the set of frequency resources to be allocated to one or more bits associated with the LP-WUS transmission according to the LP-WUS configuration;
determining a first reference signal and a second reference signal according to the LP-WUS configuration;
receiving one or more signals over the set of frequency resources from the network side device;
determining one or more signal levels according to the one or more signals; and
determining the one or more bits according to the one or more signal levels, the first reference signal, and the second reference signal.

19. The method of claim 18, wherein the determining the one or more bits according to the one or more signal levels, the first reference signal, and the second reference signal comprises:
determining a relative difference of the one or more signal levels with respect to the first reference signal and with respect to the second reference signal.

20. The method of claim 18, wherein the first reference signal comprises a first intensity representing a bit “0”, wherein the second reference signal comprises a second intensity representing a bit “1”, and wherein the determining the one or more bits according to the one or more signal levels, the first reference signal, and the second reference signal comprises:
decoding a first bit of the one or more bits to be a “1” when a difference between a first one of the one or more signal levels and the first reference signal is less than a difference between the first one of the one or more signal levels and the second reference signal.
